(19) United States
(12) Patent Application Publication
(10) Pub. No.: US 2023/0350071 A1
(43) Pub. Date: Nov. 2, 2023

(54) LIDAR DEVICE

(71) Applicant: Mitsubishi Electric Corporation, Tokyo (JP)

(72) Inventors: Masaharu IMAKI, Tokyo (JP); Takayuki NAKANO, Tokyo (JP); Yusuke ITO, Tokyo (JP)

(73) Assignee: Mitsubishi Electric Corporation, Tokyo (JP)

(21) Appl. No.: 18/221,208

(22) Filed: Jul. 12, 2023

Related U.S. Application Data
(63) Continuation of application No. PCT/JP2021/007236, filed on Feb. 26, 2021.

(51) Int. Cl. G01S 17/95; G01S 7/481; G01N 21/39

(52) U.S. Cl. CPC G01S 17/95; G01S 7/4814; G01N 21/39

(57) ABSTRACT

A lidar device radiating a first laser beam in an absorption band of a gas and a second laser beam having a lower absorption rate than that of the first laser beam to the gas in a space includes: a light source of a laser beam; a frequency outputter outputting a first frequency or a second frequency different from the former; a reference light outputter outputting the laser beam as reference light; a transmitter generating the first laser beam by modulating a frequency of the laser beam by the first frequency, generating the second laser beam by modulating the frequency of the laser beam by the second frequency, and radiating both to the space; and a receiver receiving the first laser beam and then scattered by the gas or the second laser beam and then similarly scattered and detect interference between the scattered light and the reference light.

### CROSS REFERENCE TO RELATED APPLICATIONS

This application is a Continuation of PCT International Application No. PCT/JP2021/007236, filed on Feb. 26, 2021, all of which is hereby expressly incorporated by reference into the present application.

### TECHNICAL FIELD

The present disclosure relates to a lidar device.

### BACKGROUND ART

Non-Patent Literature 1 below discloses a lidar device that calculates the density of gas present in a space. The lidar device includes a first light source that oscillates a first laser beam having a wavelength included in an absorption wavelength band of an observation target gas and a second light source that oscillates a second laser beam having a wavelength not included in the absorption wavelength band. The absorption rate of the second laser beam by the gas is lower than the absorption rate of the first laser beam by the gas. The gas present in the space corresponds to, for example, a constituent molecule in the air, and the constituent molecule in the air is nitrogen, oxygen, carbon dioxide, or water vapor. The constituent molecules in the air also include air pollutants such as nitrogen oxides (NOx).

In addition, the lidar device includes an optical switch, an optical transmission unit, an optical receiving unit, and a density calculating unit. In the lidar device, the optical switch selects the first laser beam or the second laser beam.

When the optical switch selects the first laser beam, the optical transmission unit emits the first laser beam into the space, and when the optical switch selects the second laser beam, the optical transmission unit emits the second laser beam into the space. The optical receiving unit receives first scattered light that is the first laser beam after being emitted by the optical transmission unit and then scattered by the scatterer floating in the space or second scattered light that is the second laser beam after being scattered by the scatterer, and detects interference light between the first scattered light or the second scattered light and the reference light. The scatterer corresponds to a cloud, smoke, dust, aerosol, raindrops, or the like. Then, the density calculating unit performs frequency analysis on the interference light detected by the optical receiving unit, and calculates the density of the gas from the reception intensity of the analysis result.

### CITATION LIST

### Non-Patent Literature

Non-Patent Literature 1: F. Gibert, D. Edouart, C. Cenac (“e” has an acute accent.), F. Le Mounier, and A. Dumas, “2-μm Ho emitter-based coherent DIAL for CO2 profiling in the atmosphere”, Opt. Lett. 40(13), 3093-3096 (2015).

### SUMMARY OF INVENTION

### Technical Problem

In the lidar device disclosed in Non-Patent Literature 1, in order for the density calculating unit to calculate the density of the gas, the lidar device needs to include a first light source and a second light source.

The present disclosure has been made to solve the above problems, and an object thereof is to obtain a lidar device capable of calculating the density of gas without including two light sources.

### Solution to Problem

A lidar device according to the present disclosure is a lidar device that radiates a first laser beam having a wavelength included in an absorption wavelength band of an observation target gas and a second laser beam having a lower absorption rate by the gas than that of the first laser beam to a space where the gas is present. A lidar device according to the present disclosure includes: a light source to output a laser beam; a frequency outputter to output a first frequency or a second frequency different from the first frequency; a reference light outputter to output the laser beam output from the light source as reference light; an optical transmitter to generate the first laser beam by modulating an optical frequency of the laser beam output from the light source by the first frequency, generate the second laser beam by modulating the optical frequency of the laser beam output from the light source by the second frequency, and radiate each of the first laser beam and the second laser beam to the space; and an optical receiver to receive, as scattered light, the first laser beam radiated by the optical transmitter and then scattered by a scatterer floating in the space or the second laser beam radiated by the optical transmitter and then scattered by the scatterer, and detect interference light between the scattered light and the reference light, wherein the first laser beam has a first wavelength within an absorption wavelength band of the gas to be observed and the second laser beam has a second wavelength out of the absorption wavelength band of the gas to be observed, and wherein the frequency outputter outputs the first frequency in a first period, and outputs the second frequency in a second period different from the first period.

### Advantageous Effects of Invention

According to the present disclosure, it is possible to calculate the density of gas without including two light sources.

### BRIEF DESCRIPTION OF DRAWINGS

FIG. 1 is a configuration diagram illustrating a lidar device 1 according to a first embodiment.

FIG. 2 is a configuration diagram illustrating a density calculating unit 16 of the lidar device 1 according to the first embodiment.

FIG. 3 is a hardware configuration diagram illustrating hardware of the density calculating unit 16 of the lidar device 1 according to the first embodiment.

FIG. 4 is a hardware configuration diagram of a computer in a case where the density calculating unit 16 is implemented by software, firmware, or the like.

FIG. 5 is a flowchart illustrating a processing procedure of the density calculating unit 16.

FIG. 6 is an explanatory diagram illustrating an absorption wavelength band of gas, a wavelength of a laser beam output from a light source 11, a first wavelength, and a second wavelength.

FIG. 7 is an explanatory diagram illustrating an optical frequency of scattered light, an optical frequency of reference light, and a reception spectrum in a signal in a frequency domain.

FIG. 8 is an explanatory diagram illustrating an area of a reception spectrum.

FIG. 9 is an explanatory diagram illustrating an output waveform of a second frequency oscillator 22 capable of changing a frequency Δf to be added.

FIG. 10 is an explanatory diagram illustrating wavelength sweep of a second laser beam.

FIG. 11 is a configuration diagram illustrating another lidar device 1 according to the first embodiment.

FIG. 12 is a configuration diagram illustrating a lidar device 1 according to a second embodiment.

FIG. 13 is a configuration diagram illustrating a temperature calculating unit 84 of the lidar device 1 according to the second embodiment.

FIG. 14 is a hardware configuration diagram illustrating hardware of the temperature calculating unit 84 of the lidar device 1 according to the second embodiment.

FIG. 15 is a hardware configuration diagram of a computer in a case where the temperature calculating unit 84 is implemented by software, firmware, or the like.

FIG. 16 is an explanatory diagram illustrating an absorption wavelength band of gas, a wavelength of the laser beam output from the light source 11, a first wavelength, a second wavelength, and a third wavelength.

FIG. 17 is a configuration diagram illustrating a lidar device 1 according to a third embodiment.

FIG. 18 is a configuration diagram illustrating another lidar device 1 according to the third embodiment.

FIG. 19 is a configuration diagram illustrating a lidar device 1 according to a fourth embodiment.

FIG. 20 is an explanatory diagram illustrating a relationship between a digital signal provided to a frequency analysis unit 51 and a distance range corresponding to each time gate.

FIG. 21 is an explanatory diagram illustrating a signal in a frequency domain for each distance range and a reception spectrum for each distance range.

FIG. 22 is an explanatory diagram illustrating an area of a reception spectrum and a frequency difference between two reception spectra.

FIG. 23 is a configuration diagram illustrating a lidar device 1 according to a fifth embodiment.

### DESCRIPTION OF EMBODIMENTS

Hereinafter, in order to describe the present disclosure in more detail, embodiments for carrying out the present disclosure will be described with reference to the accompanying drawings.

### First Embodiment

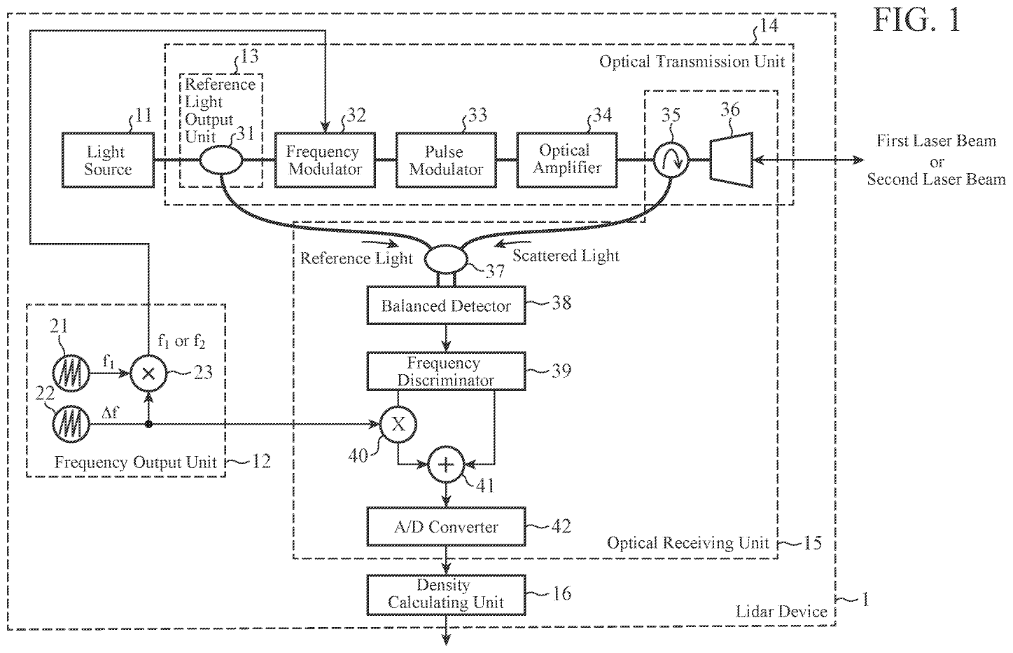

FIG. 1 is a configuration diagram illustrating a lidar device 1 according to a first embodiment.

In the first embodiment, it is assumed that a gas that is a gas to be observed (hereinafter referred to as “observation target gas”) is present in the air in which the lidar device 1 is installed. However, this is merely an example, and the observation target gas may not be present in the air in which the lidar device 1 is installed, and the observation target gas may be present in another space via a window or the like.

The lidar device 1 illustrated in FIG. 1 includes a light source 11, a frequency output unit 12, a reference light output unit 13, an optical transmission unit 14, an optical receiving unit 15, and a density calculating unit 16.

The light source 11 is, for example, a laser that emits and a laser beam of a single frequency, and is implemented by a semiconductor laser, a fiber laser, or a solid-state laser whose emission spectrum has a line width of several MHz or less. Alternatively, the light source 11 is implemented by a combination of one or more lasers among a semiconductor laser, a fiber laser, and a solid-state laser.

The light source 11 outputs the first laser beam that is continuous light to each of the reference light output unit 13 and the optical transmission unit 14. The optical frequency of the laser beam output from the light source 11 is f₀.

The frequency output unit 12 includes a first frequency oscillator 21, a second frequency oscillator 22, and a frequency mixer 23.

The frequency output unit 12 outputs a first frequency f₁ or a second frequency f₂ different from the first frequency f₁ to the optical transmission unit 14.

The first frequency oscillator 21 oscillates a first frequency f₁ and outputs the first frequency f₁ to the frequency mixer 23.

The second frequency oscillator 22 intermittently oscillates a frequency Δf to be added to the first frequency f₁, and intermittently outputs the frequency Δf to be added to the frequency mixer 23.

When outputting the frequency Δf to be added to the frequency mixer 23, the second frequency oscillator 22 outputs the frequency Δf to be added to the frequency mixer 40 described later.

When not outputting the frequency Δf to be added to the frequency mixer 23, the second frequency oscillator 22 does not output the frequency Δf to be added to the frequency mixer 40.

The frequency mixer 23 is implemented by, for example, a mixer.

When the frequency Δf to be added is not output from the second frequency oscillator 22, the frequency mixer 23 outputs the first frequency f₁ oscillated by the first frequency oscillator 21 to a frequency modulator 32 described later.

When the frequency Δf to be added is output from the second frequency oscillator 22, the frequency mixer 23 outputs the frequency f₁+Δf, which is the sum of the first frequency f₁ oscillated by the first frequency oscillator 21 and the frequency Δf to be added, to the optical transmission unit 14 as the second frequency f₂.

The reference light output unit 13 includes an optical distributor 31.

The reference light output unit 13 outputs the laser beam output from the light source 11 to the optical receiving unit 15 as reference light.

The optical distributor 31 is implemented by, for example, a beam splitter or a fiber type coupler.

The optical distributor 31 distributes the laser beam output from the light source 11 at a predetermined ratio. The predetermined ratio is, for example, a ratio of 90 on the frequency modulator 32 side and a ratio of 10 on the optical multiplexer 37 side to be described later.

The optical distributor 31 outputs one of the distributed laser beams to the frequency modulator 32 and outputs the other of the distributed laser beams to the optical multiplexer 37.

The optical transmission unit 14 includes an optical distributor 31, a frequency modulator 32, a pulse modulator 33, an optical amplifier 34, an optical circulator 35, and an optical antenna 36.

The optical transmission unit 14 generates a first laser beam by modulating the optical frequency of the laser beam output from the light source 11 by the first frequency f₁, and radiates the first laser beam into space. The first laser beam is laser beam having a first wavelength included in an absorption wavelength band of an observation target gas.

The optical transmission unit 14 generates a second laser beam by modulating the optical frequency of the laser beam output from the light source 11 by the second frequency f₂, and radiates the second laser beam into space. The second laser beam is a laser beam having a second wavelength not included in the absorption wavelength band of the observation target gas, and has a lower absorption rate by the gas than that of the first laser beam.

Examples of the gas present in space include constituent molecules in the atmosphere, and examples of the scatterer include clouds, smoke, dust, aerosols, rain drops, and the like. The constituent molecule in the atmosphere is nitrogen, oxygen, carbon dioxide, or water vapor. The constituent molecules in the air also include air pollutants such as nitrogen oxides (NOx). In the lidar device 1 shown in FIG. 1, the absorption wavelength band of the gas is an already-made value. Note that the scatterer may be a hard target such as a structure.

The frequency modulator 32 is implemented by, for example, a modulation element using an acousto-optic element or a modulation element using a lithium niobate crystal.

When the first frequency f₁ is output from the frequency mixer 23, the frequency modulator 32 modulates the optical frequency f₀ of the laser beam output from the optical distributor 31 by the first frequency f₁, and outputs the frequency-modulated laser beam to the pulse modulator 33 as the first laser beam. The optical frequency of the first laser beam is f₀+f₁.

When the second frequency f₂ is output from the frequency mixer 23, the frequency modulator 32 modulates the optical frequency f₀ of the laser beam output from the optical distributor 31 by the second frequency f₂, and outputs the laser beam modulated by the second frequency to the pulse modulator 33 as the second laser beam. The optical frequency of the second laser beam is f₀+f₂.

The pulse modulator 33 is implemented by, for example, a modulation element using an acousto-optic element or a modulation element using a lithium niobate crystal, and an optical amplifier such as a semiconductor optical amplifier.

When the first laser beam is output from the frequency modulator 32, the pulse modulator 33 pulse-modulates the first laser beam. That is, the pulse modulator 33 converts the first laser beam that is continuous light into pulse light having a predetermined pulse width.

The pulse modulator 33 outputs the pulse-modulated first laser beam, which is pulse light, to the optical amplifier 34.

When the second laser beam is output from the frequency modulator 32, the pulse modulator 33 pulse-modulates the second laser beam. That is, the pulse modulator 33 converts the second laser beam, which is continuous light, into pulse light having a predetermined pulse width.

The pulse modulator 33 outputs the pulse-modulated second laser beam, which is pulse light, to the optical amplifier 34.

When the pulse-modulated first laser beam is output from the pulse modulator 33, the optical amplifier 34 amplifies the pulse-modulated first laser beam and outputs the amplified first laser beam to the optical circulator 35.

When the pulse-modulated second laser beam is output from the pulse modulator 33, the optical amplifier 34 amplifies the pulse-modulated second laser beam and outputs the amplified second laser beam to the optical circulator 35.

The optical circulator 35 is implemented by, for example, a polarization beam splitter and a wavelength plate.

When the amplified first laser beam is output from the optical amplifier 34, the optical circulator 35 outputs the amplified first laser beam to the optical antenna 36, and outputs scattered light (described later) collected by the optical antenna 36 to the optical multiplexer 37.

When the amplified second laser beam is output from the optical amplifier 34, the optical circulator 35 outputs the amplified second laser beam to the optical antenna 36, and outputs scattered light collected by the optical antenna 36 to the optical multiplexer 37.

The optical antenna 36 is implemented by, for example, a plurality of refraction lenses or a plurality of mirrors.

When the first laser beam is output from the optical circulator 35, the optical antenna 36 radiates the first laser beam to a space where gas is present.

The optical antenna 36 receives scattered light that is the first laser beam scattered by the scatterer floating in the space, and outputs the scattered light to the optical circulator 35.

When the second laser beam is output from the optical circulator 35, the optical antenna 36 radiates the second laser beam to the space where the gas is present.

The optical antenna 36 receives scattered light that is the second laser beam scattered by the scatterer floating in the space, and outputs the scattered light to the optical circulator 35.

The optical receiving unit 15 includes an optical circulator 35, an optical antenna 36, an optical multiplexer 37, a balanced detector 38, a frequency discriminator 39, a frequency mixer 40, a signal multiplexer 41, and an analog/digital converter (hereinafter referred to as “A/D converter”) 42.

The optical receiving unit 15 receives, as scattered light, the first laser beam after being radiated by the optical transmission unit 14 and then scattered by the scatterer or the second laser beam after being radiated by the optical transmission unit 14 and then scattered by the scatterer.

That is, the optical receiving unit 15 receives the first laser beam scattered by the scatterer as scattered light when the optical receiving unit 15 radiates the first laser beam into the space, and receives the second laser beam scattered by the scatterer as scattered light when the optical receiving unit 15 radiates the second laser beam into the space.

The optical receiving unit 15 detects interference light between scattered light and reference light.

The optical multiplexer 37 is implemented by, for example, a beam splitter or a fiber type coupler.

The optical multiplexer 37 detects interference light between scattered light output from the optical circulator 35 and reference light output from the optical distributor 31.

The optical multiplexer 37 outputs the interference light to the balanced detector 38.

For example, in a case where the lidar device 1 is moving, or in a case where the gas and the scatterer are moving due to wind or the like, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Δf_{sft}. When the lidar device 1 and the scatterer or the like are away from each other, the optical frequencies f₀+f₁ and f₀+f₂ of the scattered light are decreased by, for example, the frequency Δf_{sft}.

Therefore, when the lidar device 1 and the scatterer or the like are close to each other, the optical multiplexer 37 outputs the interference light having the optical frequency f₁+Δf_{sft} to the balanced detector 38 if the scattered light which is the scattered first laser beam is output from the optical circulator 35, and outputs the interference light having the optical frequency f₂+Δf_{sft} to the balanced detector 38 if the scattered light which is the scattered second laser beam is output from the optical circulator 35.

When the lidar device 1 and the scatterer or the like are away from each other, the optical multiplexer 37 outputs the interference light having the optical frequency f₁-Δf_{sft} to the balanced detector 38 if the scattered light which is the scattered first laser beam is output from the optical circulator 35, and outputs the interference light having the optical frequency f₂−Δf_{sft} to the balanced detector 38 if the scattered light which is the scattered second laser beam is output from the optical circulator 35.

When the lidar device 1 is not moved and the gas and the scatterer are not moved, the optical frequencies f₀+f₁ and f₀+f₂ of the scattered light are not shifted. Therefore, the optical multiplexer 37 outputs the interference light having the optical frequency f₁ to the balanced detector 38 if the scattered light that is the scattered first laser beam is output from the optical circulator 35, and outputs the interference light having the optical frequency f₂ to the balanced detector 38 if the scattered light that is the scattered second laser beam is output from the optical circulator 35.

The balanced detector 38 is implemented by, for example, a balanced receiver that reduces in-phase noise by using two photodiodes.

The balanced detector 38 converts the interference light output from the optical multiplexer 37 into an electric signal.

The balanced detector 38 outputs the electric signal to the frequency discriminator 39.

When the electric signal related to the interference light having the optical frequency f₂+Δf_{sft}, the electric signal related to the interference light having the optical frequency f₂−Δf_{sft}, or the electric signal related to the interference light having the optical frequency f₂ is output from the balanced detector 38, the frequency discriminator 39 outputs these electric signals to the frequency mixer 40.

When the electric signal related to the interference light having the optical frequency f₁+Δf_{sft}, the electric signal related to the interference light having the optical frequency f₁−Δf_{sft}, or the electric signal related to the interference light having the optical frequency f₁ is output from the balanced detector 38, the frequency discriminator 39 outputs these electric signals to the signal multiplexer 41.

The frequency mixer 40 is implemented by, for example, a mixer.

The frequency mixer 40 down-converts the frequency of the electric signal output from the frequency discriminator 39 using the frequency Δf to be added output from the second frequency oscillator 22.

That is, when the frequency of the electric signal output from the frequency discriminator 39 is f₂+Δf_{sft}, the frequency mixer 40 down-converts the frequency of the electric signal to f₁+Δf_{sft} using the frequency Δf to be added.

When the frequency of the electric signal output from the frequency discriminator 39 is f₂−Δf_{sft}, the frequency mixer 40 down-converts the frequency of the electric signal to f₁−Δf_{sft} using the frequency Δf to be added.

When the frequency of the electric signal output from the frequency discriminator 39 is f₂, the frequency mixer 40 down-converts the frequency of the electric signal to f₁ using the frequency Δf to be added.

The frequency mixer 40 outputs the down-converted electric signal to the signal multiplexer 41.

Upon receiving the electric signal from the frequency discriminator 39, the signal multiplexer 41 outputs the electric signal to the A/D converter 42.

Upon receiving the electric signal from the frequency mixer 40, the signal multiplexer 41 outputs the electric signal to the A/D converter 42.

The A/D converter 42 converts an analog electric signal output from the signal multiplexer 41 into a digital signal.

The A/D converter 42 outputs the digital signal to the density calculating unit 16.

Then, the density calculating unit 16 analyzes a frequency of the interference light detected by the optical receiving unit 15, and calculates the density of the gas from the analysis result of the frequency.

The lidar device 1 illustrated in FIG. 1 includes a density calculating unit 16. However, this is merely an example, and the lidar device 1 may not include the density calculating unit 16, and a computer or the like different from the lidar device 1 may implement the density calculating unit 16. In this case, the A/D converter 42 outputs the digital signal to a computer or the like different from the lidar device 1.

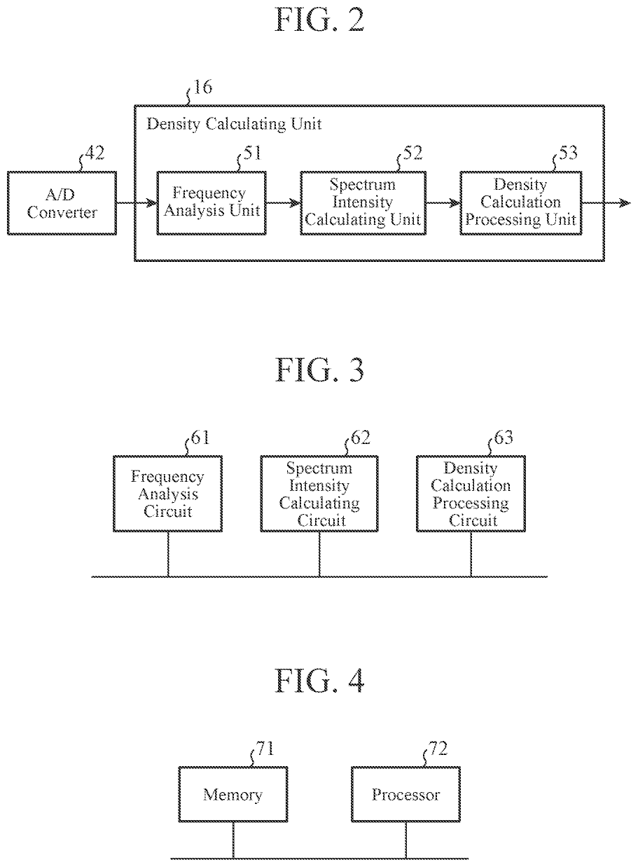

FIG. 2 is a configuration diagram illustrating the density calculating unit 16 of the lidar device 1 according to the first embodiment.

FIG. 3 is a hardware configuration diagram illustrating hardware of the density calculating unit 16 of the lidar device 1 according to the first embodiment.

The density calculating unit 16 illustrated in FIG. 2 includes a frequency analysis unit 51, a spectrum intensity calculating unit 52, and a density calculation processing unit 53.

The frequency analysis unit 51 is implemented by, for example, a frequency analysis circuit 61 illustrated in FIG. 3.

The frequency analysis unit 51 converts the digital signal output from the A/D converter 42 into a signal in a frequency domain by performing fast Fourier transform on the digital signal for each predetermined time gate.

The frequency analysis unit 51 outputs the signal in frequency domain for a plurality of distance ranges to the spectrum intensity calculating unit 52.

The spectrum intensity calculating unit 52 is implemented by, for example, a spectrum intensity calculating circuit 62 shown in FIG. 3.

The spectrum intensity calculating unit 52 calculates the intensity of the reception spectrum for each distance range from the signal in frequency domain for each distance range output from the frequency analysis unit 51.

That is, when the interference light having the optical frequency f₁+Δf_{sft} or the interference light having the optical frequency f₂+Δf_{sft} is detected by the optical multiplexer 37, the spectrum intensity calculating unit 52 calculates the intensity of the reception spectrum at the frequency f₁+Δf_{sft} for each distance range.

When the interference light having the optical frequency f₁−Δf_{sft} or the interference light having the optical frequency f₂−Δf_{sft} is detected by the optical multiplexer 37, the spectrum intensity calculating unit 52 calculates the intensity of the reception spectrum at the frequency f₁−Δf_{sft} for each distance range.

When the interference light having the optical frequency f₁ or the interference light having the optical frequency f₂ is detected by the optical multiplexer 37, the spectrum intensity calculating unit 52 calculates the intensity of the reception spectrum at the frequency f₁ for each distance range.

The spectrum intensity calculating unit 52 outputs the intensity of the reception spectrum for each distance range to the density calculation processing unit 53.

The density calculation processing unit 53 is implemented by, for example, a density calculation processing circuit 63 shown in FIG. 3.

The density calculation processing unit 53 calculates the density of the gas from the intensity of the reception spectrum for each distance range output from the spectrum intensity calculating unit 52.

In FIG. 2, it is assumed that each of the frequency analysis unit 51, the spectrum intensity calculating unit 52, and the density calculation processing unit 53, which are components of the density calculating unit 16, is implemented by dedicated hardware as illustrated in FIG. 3. That is, it is assumed that the density calculating unit 16 is implemented by the frequency analysis circuit 61, the spectrum intensity calculating circuit 62, and the density calculation processing circuit 63.

Each of the frequency analysis circuit 61, the spectrum intensity calculating circuit 62, and the density calculation processing circuit 63 corresponds to, for example, a single circuit, a composite circuit, a programmed processor, a parallel-programmed processor, an application specific integrated circuit (ASIC), a field-programmable gate array (FPGA), or a combination thereof.

The components of the density calculating unit 16 are not limited to those implemented by dedicated hardware, and the density calculating unit 16 may be implemented by software, firmware, or a combination of software and firmware.

The software or firmware is stored in a memory of a computer as a program. The computer means hardware that executes a program, and corresponds to, for example, a central processing unit (CPU), a central processing unit, a processing unit, an arithmetic unit, a microprocessor, a microcomputer, a processor, or a digital signal processor (DSP).

FIG. 4 is a hardware configuration diagram of a computer in a case where the density calculating unit 16 is implemented by software, firmware, or the like.

In a case where the density calculating unit 16 is implemented by software, firmware, or the like, a program for causing a computer to execute respective processing procedures in the frequency analysis unit 51, the spectrum intensity calculating unit 52, and the density calculation processing unit 53 is stored in a memory 71. Then, a processor 72 of the computer executes the program stored in the memory 71.

Furthermore, FIG. 3 illustrates an example in which each of the components of the density calculating unit 16 is implemented by dedicated hardware, and FIG. 4 illustrates an example in which the density calculating unit 16 is implemented by software, firmware, or the like. However, this is merely an example, and some components in the density calculating unit 16 may be implemented by dedicated hardware, and the remaining components may be implemented by software, firmware, or the like.

Next, the operation of the lidar device 1 illustrated in FIG. 1 will be described.

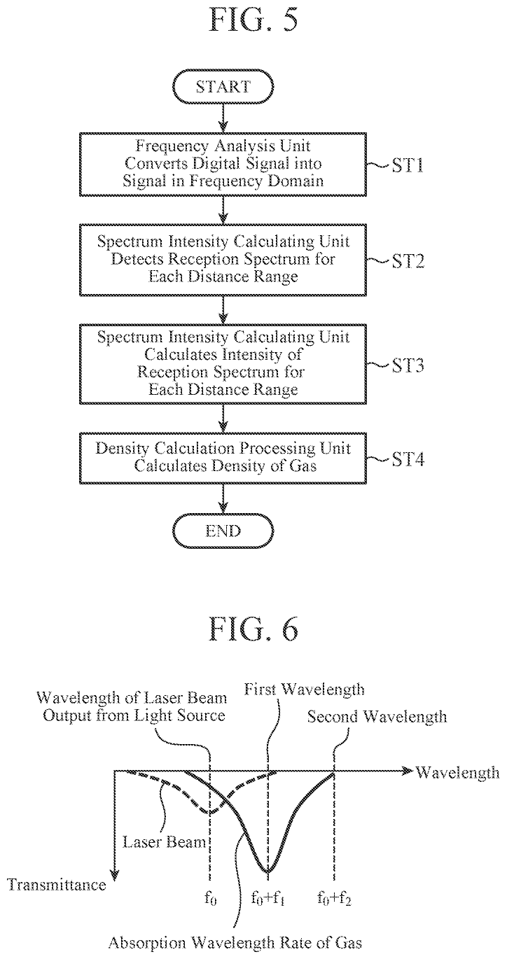

FIG. 5 is a flowchart illustrating a processing procedure of the density calculating unit 16.

The light source 11 outputs a laser beam that is continuous light to the optical distributor 31.

The frequency output unit 12 outputs the first frequency f₁ or the second frequency f₂ to the optical transmission unit 14. For example, the frequency output unit 12 alternately outputs the first frequency f₁ and the second frequency f₂ to the optical transmission unit 14.

Hereinafter, the frequency output operation by the frequency output unit 12 will be specifically described.

The first frequency oscillator 21 oscillates a first frequency f₁ and outputs the first frequency f₁ to the frequency mixer 23.

The second frequency oscillator 22 intermittently oscillates the frequency Δf to be added, and intermittently outputs the frequency Δf to be added to the frequency mixer 23.

When outputting the frequency Δf to be added to the frequency mixer 23, the second frequency oscillator 22 outputs the frequency Δf to be added to the frequency mixer 40.

When not outputting the frequency Δf to be added to the frequency mixer 23, the second frequency oscillator 22 does not output the frequency Δf to be added to the frequency mixer 40.

When the frequency Δf to be added is not output from the second frequency oscillator 22, the frequency mixer 23 outputs the first frequency f₁ oscillated by the first frequency oscillator 21 to the frequency modulator 32.

When the frequency Δf to be added is output from the second frequency oscillator 22, the frequency mixer 23 outputs the frequency f₁+Δf of the sum of the first frequency f₁ and the frequency Δf to be added to the frequency modulator 32 as the second frequency f₂.

The first frequency oscillator 21 generates a sine wave signal corresponding to the first frequency f₁ in a case where the frequency modulator 32 is implemented by a modulation element using an acousto-optic element, and generates a sawtooth wave signal to be serrodyne modulation in a case where the frequency modulator 32 is implemented by a modulation element using a lithium niobate crystal.

In addition, also the second frequency oscillator 22, generates a sine wave signal corresponding to the frequency Δf to be added in a case where the frequency modulator 32 is implemented by a modulation element using an acousto-optic element, and generates a sawtooth wave signal to be serrodyne modulation in a case where the frequency modulator 32 is implemented by a modulation element using a lithium niobate crystal.

In general, in a case where the frequency modulator 32 is implemented by a modulation element using an acousto-optic element, frequency modulation by the frequency modulator 32 is about several hundred MHz at most.

On the other hand, in a case where the frequency modulator 32 is implemented by a modulation element using a lithium niobate crystal, frequency modulation by the frequency modulator 32 can be performed up to about several tens of GHz. In a case where the frequency modulator 32 is implemented by a modulation element using a lithium niobate crystal, it is possible to implement a shift of a wavelength larger than the line width of the absorption line of the gas that is the observation target gas. Therefore, the frequency modulator 32 can output the first laser beam having the first wavelength included in the absorption wavelength band of the gas by frequency-modulating the optical frequency f₀ of the laser beam having a stable wavelength by the first frequency f₁. In addition, the frequency modulator 32 can output the second laser beam having the second wavelength not included in the absorption wavelength band of the gas by frequency-modulating the optical frequency f₀ of the laser beam by the second frequency f₂.

Upon receiving the laser beam from the light source 11, the optical distributor 31 distributes the laser beam at a predetermined ratio.

The optical distributor 31 outputs one of the distributed laser beams to the frequency modulator 32, and outputs the other of the distributed laser beams to the optical multiplexer 37 as reference light.

The frequency modulator 32 acquires the laser beam from the optical distributor 31.

When acquiring the first frequency f₁ from the frequency mixer 23, the frequency modulator 32 modulates the optical frequency f₀ of the laser beam output from the optical distributor 31 by the first frequency f₁.

The frequency modulator 32 outputs the laser beam modulated by the first frequency f₁ to the pulse modulator 33 as the first laser beam. The first laser beam has a first wavelength, and an optical frequency of the first laser beam is f₀+f₁.

When acquiring the second frequency f₂ from the frequency mixer 23, the frequency modulator 32 modulates the optical frequency f₀ of the laser beam by the second frequency f₂.

The frequency modulator 32 outputs the laser beam modulated by the second frequency f₂ to the pulse modulator 33 as the second laser beam. The second laser beam has a second wavelength, and the optical frequency of the second laser beam is f₀+f₂.

FIG. 6 is an explanatory diagram illustrating an absorption wavelength band of gas, a wavelength of a laser beam output from the light source 11, a first wavelength, and a second wavelength.

In FIG. 6, the horizontal axis represents the wavelength, and the vertical axis represents the transmittance of the laser beam to the gas.

A broken line indicates a laser beam output from the light source 11, and a solid line indicates an absorption wavelength band of gas. The first wavelength is included in the absorption wavelength band of the gas, and the second wavelength is not included in the absorption wavelength band of the gas. The transmittance of the second wavelength by the gas is greater than the transmittance of the first wavelength by the gas. That is, the absorption rate of the second wavelength by the gas is smaller than the absorption rate of the first wavelength by the gas.

When acquiring the first laser beam from the frequency modulator 32, the pulse modulator 33 pulse-modulates the first laser beam. That is, the pulse modulator 33 converts the first laser beam that is continuous light into pulse light having a predetermined pulse width.

The pulse modulator 33 outputs the pulse-modulated first laser beam, which is pulse light, to the optical amplifier 34.

When acquiring the second laser beam from the frequency modulator 32, the pulse modulator 33 pulse-modulates the second laser beam. That is, the pulse modulator 33 converts the second laser beam, which is continuous light, into pulse light having a predetermined pulse width.

The pulse modulator 33 outputs the pulse-modulated second laser beam, which is pulse light, to the optical amplifier 34.

In the pulse-type lidar device 1, the distance resolution is determined by the pulse width of the pulse light. Assuming that the pulse width is t [s] and the light speed is c [m/s], the distance resolution R [m] is expressed by the following Formula (1).

R=c×t/2 (1)

When acquiring the pulse-modulated first laser beam from the pulse modulator 33, the optical amplifier 34 amplifies the pulse-modulated first laser beam and outputs the amplified first laser beam to the optical circulator 35.

When acquiring the pulse-modulated second laser beam from the pulse modulator 33, the optical amplifier 34 amplifies the pulse-modulated second laser beam and outputs the amplified second laser beam to the optical circulator 35.

When acquiring the amplified first laser beam from the optical amplifier 34, the optical circulator 35 outputs the amplified first laser beam to the optical antenna 36.

When acquiring the amplified second laser beam from the optical amplifier 34, the optical circulator 35 outputs the amplified second laser beam to the optical antenna 36.

Upon receiving the first laser beam from the optical circulator 35, the optical antenna 36 radiates the first laser beam to a space where gas is present.

The optical antenna 36 receives scattered light that is the first laser beam scattered by the scatterer floating in the space, and outputs the scattered light to the optical circulator 35.

The optical circulator 35 outputs the scattered light collected by the optical antenna 36 to the optical multiplexer 37.

Upon receiving the second laser beam from the optical circulator 35, the optical antenna 36 radiates the second laser beam to the space where the gas is present.

The optical antenna 36 receives scattered light that is the second laser beam scattered by the scatterer floating in the space, and outputs the scattered light to the optical circulator 35.

The optical circulator 35 outputs the scattered light collected by the optical antenna 36 to the optical multiplexer 37.

The optical multiplexer 37 acquires the scattered light from the optical circulator 35 and acquires reference light from the optical distributor 31.

The optical multiplexer 37 detects interference light between the scattered light and the reference light.

For example, when the lidar device 1 moves or the gas and the scatterer move, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Δf_{sft}. Since the optical frequency of the reference light is f₀, the optical frequencies of the interference light are f₁+Δf_{sft}(=f₀+f₁+Δf_{sft}−f₀) and f₂+Δf_{sft}(=f₀+f₂+Δf_{sft}−f₀).

When the lidar device 1 and the scatterer or the like are away from each other, the optical frequencies f₀+f₁ and f₀+f₂ of the scattered light are decreased by, for example, the frequency Δf_{sft}. Since the optical frequency of the reference light is f₀, the optical frequencies of the interference light are f₁−Δf_{sft} (=f₀+f₁−Δf_{sft}−f₀) and f₂−Δf_{sft} (=f₀+f₂−Δf_{sft}−f₀).

Therefore, when the lidar device 1 and the scatterer or the like are close to each other, if scattered light that is the scattered first laser beam is output from the optical circulator 35, the optical multiplexer 37 outputs interference light having an optical frequency f₁+Δf_{sft} to the balanced detector 38.

Furthermore, when the lidar device 1 and the scatterer or the like are close to each other, if scattered light that is the scattered second laser beam is output from the optical circulator 35, the optical multiplexer 37 outputs interference light having an optical frequency f₂+Δf_{sft} to the balanced detector 38.

When the lidar device 1 and the scatterer or the like are away from each other, if scattered light that is the scattered first laser beam is output from the optical circulator 35, the optical multiplexer 37 outputs interference light having an optical frequency f₁−Δf_{sft} to the balanced detector 38.

Furthermore, when the lidar device 1 and the scatterer or the like are away from each other, if scattered light that is the scattered second laser beam is output from the optical circulator 35, the optical multiplexer 37 outputs interference light having an optical frequency f₂−Δf_{sft} to the balanced detector 38.

When the lidar device 1 does not move and the gas and the scatterer do not move, the optical multiplexer 37 outputs the interference light having the optical frequency f₁ to the balanced detector 38 if the scattered light that is the scattered first laser beam is output from the optical circulator 35, and outputs the interference light having the optical frequency f₂ to the balanced detector 38 if the scattered light that is the scattered second laser beam is output from the optical circulator 35.

The balanced detector 38 acquires interference light from the optical multiplexer 37 and converts the interference light into an electric signal.

The balanced detector 38 outputs the electric signal to the frequency discriminator 39.

When the frequency discriminator 39 acquires an electric signal related to the interference light having the optical frequency f₂+Δf_{sft}, an electric signal related to the interference light having the optical frequency f₂−Δf_{sft}, or an electric signal related to the interference light having the optical frequency f₂ from the balanced detector 38, the frequency discriminator outputs the acquired electric signal to the frequency mixer 40.

When the frequency discriminator 39 acquires an electric signal related to the interference light having the optical frequency f₁+Δf_{sft}, an electric signal related to the interference light having the optical frequency f₁−Δf_{sft}, or an electric signal related to the interference light having the optical frequency f₁ from the balanced detector 38, the frequency discriminator outputs the acquired electric signal to the signal multiplexer 41.

The frequency mixer 40 receives a frequency Δf (=f₂−f₁) to be added output from the second frequency oscillator 22, and acquires an electric signal from the frequency discriminator 39.

When the frequency of the electric signal output from the frequency discriminator 39 is f₂+Δf_{sft}, the frequency mixer 40 down-converts the frequency of the electric signal to f₁+Δf_{sft} using the frequency Δf to be added.

When the frequency of the electric signal output from the frequency discriminator 39 is f₂−Δf_{sft}, the frequency mixer 40 down-converts the frequency of the electric signal to f₁−Δf_{sft} using the frequency Δf to be added.

The frequency mixer 40 outputs the down-converted electric signal to the signal multiplexer 41.

Upon receiving the electric signal from the frequency discriminator 39, the signal multiplexer 41 outputs the electric signal to the A/D converter 42.

That is, when acquiring the electric signal having the frequency f₁+Δf_{sft}, the electric signal having the frequency f₁−Δf_{sft}, or the electric signal having the frequency f₁ from the frequency discriminator 39, the signal multiplexer 41 outputs the electric signal having the frequency f₁+Δf_{sft}, the electric signal having the frequency f₁−Δf_{sft}, or the electric signal having the frequency f₁ to the A/D converter 42.

Upon receiving the electric signal from the frequency mixer 40, the signal multiplexer 41 outputs the electric signal to the A/D converter 42.

That is, when acquiring the electric signal having the frequency f₁+Δf_{sft}, the electric signal having the frequency f₁−Δf_{sft}, or the electric signal having the frequency f₁ from the frequency mixer 40, the signal multiplexer 41 outputs the electric signal having the frequency f₁+Δf_{sft}, the electric signal having the frequency f₁−Δf_{sft}, or the electric signal having the frequency f₁ to the A/D converter 42.

The A/D converter 42 acquires the electric signal from the signal multiplexer 41.

The A/D converter 42 converts the analog electric signal into a digital signal, and outputs the digital signal to the frequency analysis unit 51 of the density calculating unit 16.

The frequency analysis unit 51 of the density calculating unit 16 acquires the digital signal from the A/D converter 42.

That is, when the optical multiplexer 37 has detected the interference light between the scattered light which is the scattered first laser beam and the reference light, the frequency analysis unit 51 acquires the digital signal related to the electric signal output from the frequency discriminator 39 from the A/D converter 42.

When the optical multiplexer 37 has detected the interference light between the scattered light which is the scattered second laser beam and the reference light, the frequency analysis unit 51 acquires the digital signal related to the electric signal output from the frequency mixer 40 from the A/D converter 42.

The frequency analysis unit 51 converts the digital signal into a signal in the frequency domain by performing fast Fourier transform on the acquired digital signal for each predetermined time gate (step ST1 in FIG. 5).

The frequency analysis unit 51 outputs the signal in the frequency domain for a distance range corresponding to each time gate to the spectrum intensity calculating unit 52.

The spectrum intensity calculating unit 52 acquires the signal in the frequency domain for each distance range from the frequency analysis unit 51.

When the lidar device 1 and the scatterer or the like are close to each other, if the optical multiplexer 37 detects the interference light having the optical frequency f₁+Δf_{sft}, the spectrum intensity calculating unit 52 detects the reception spectrum at the frequency f₁+Δf_{sft} from the signal in the frequency domain for each distance range (step ST2 in FIG. 5). The reception spectrum at the frequency f₁+Δf_{sft} detected by the spectrum intensity calculating unit 52 is a spectrum obtained by converting a digital signal related to an electric signal having the frequency f₁+Δf_{sft} output from the frequency discriminator 39 into a signal in the frequency domain when the first laser beam is radiated.

Furthermore, when the lidar device 1 and the scatterer or the like are close to each other, if the optical multiplexer 37 detects the interference light having the optical frequency f₂+Δf_{sft}, the spectrum intensity calculating unit 52 detects the reception spectrum at the frequency f₁+Δf_{sft} from the signal in the frequency domain for each distance range (step ST2 in FIG. 5). The reception spectrum at the frequency f₁+Δf_{sft} detected by the spectrum intensity calculating unit 52 is a spectrum obtained by converting the digital signal related to an electric signal having the frequency f₁+Δf_{sft} output from the frequency mixer 40 into a signal in the frequency domain when the second laser beam is radiated.

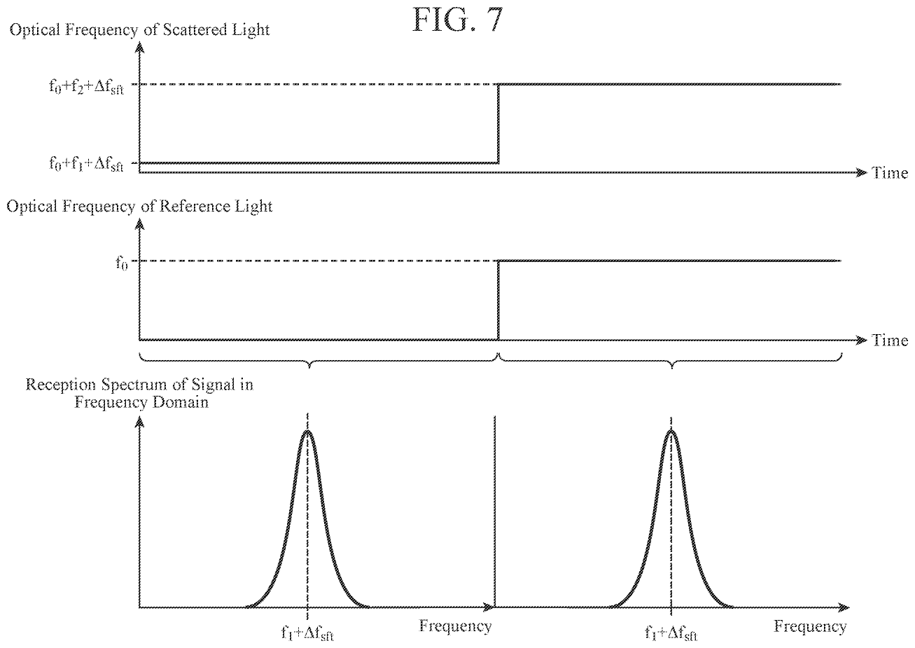

FIG. 7 is an explanatory diagram illustrating an optical frequency of scattered light, an optical frequency of reference light, and a reception spectrum in a signal in the frequency domain.

FIG. 7 illustrates the optical frequencies f₀+f₁+Δf_{sft} and f₀+f₂+Δf_{sft} of the scattered light when the lidar device 1 and the scatterer or the like are close to each other due to the movement of the lidar device 1 or the movement of the gas and the scatterer.

The optical frequency of the reference light is f₀. The frequency when the reception spectrum of the signal in the frequency domain is at the peak is f₁+Δf_{sft} even when the optical circulator 35 receives scattered light that is the scattered first laser beam or receives scattered light that is the scattered second laser beam.

When the lidar device 1 and the scatterer or the like are away from each other, if the optical multiplexer 37 detects the interference light having the optical frequency f₁−Δf_{sft}, the spectrum intensity calculating unit 52 detects the reception spectrum at the frequency f₁−Δf_{sft} for each distance range (step ST2 in FIG. 5). The reception spectrum at the frequency f₁−Δf_{sft} detected by the spectrum intensity calculating unit 52 is a spectrum obtained by converting the digital signal related to the electric signal having the frequency f₁−Δf_{sft} output from the frequency discriminator 39 into a signal in the frequency domain when the first laser beam is radiated.

In addition, when the lidar device 1 and the scatterer or the like are away from each other, if the optical multiplexer 37 detects the interference light having the optical frequency f₂−Δf_{sft}, the spectrum intensity calculating unit 52 detects the reception spectrum at the frequency f₁−Δf_{sft} for each distance range (step ST2 in FIG. 5). The reception spectrum at the frequency f₁−Δf_{sft} detected by the spectrum intensity calculating unit 52 is a spectrum obtained by converting the digital signal related to the electric signal having the frequency f₁−Δf_{sft} output from the frequency mixer 40 into a signal in the frequency domain when the second laser beam is radiated.

When the lidar device 1 does not move and the gas and the scatterer do not move, if the optical multiplexer 37 detects the interference light having the optical frequency f₁, the spectrum intensity calculating unit 52 detects the reception spectrum at the frequency f₁ for each distance range (step ST2 in FIG. 5). The reception spectrum at the frequency f₁ detected by the spectrum intensity calculating unit 52 is a spectrum obtained by converting the digital signal related to the electric signal having the frequency f₁ output from the frequency discriminator 39 into a signal in the frequency domain when the first laser beam is radiated.

In addition, when the lidar device 1 does not move and the gas and the scatterer do not move, if the optical multiplexer 37 detects the interference light having the optical frequency f₂, the spectrum intensity calculating unit 52 detects the reception spectrum at the frequency f₁ for each distance range (step ST2 in FIG. 5). The reception spectrum at the frequency f₁ detected by the spectrum intensity calculating unit 52 is a spectrum obtained by converting the digital signal related to the electric signal having the frequency f₁ output from the frequency mixer 40 into a signal in the frequency domain when the second laser beam is radiated.

If the lidar device 1 and the scatterer or the like are close to each other, the spectrum intensity calculating unit 52 calculates the intensity of the reception spectrum at the frequency f₁+Δf_{sft} for each distance range (step ST3 in FIG. 5).

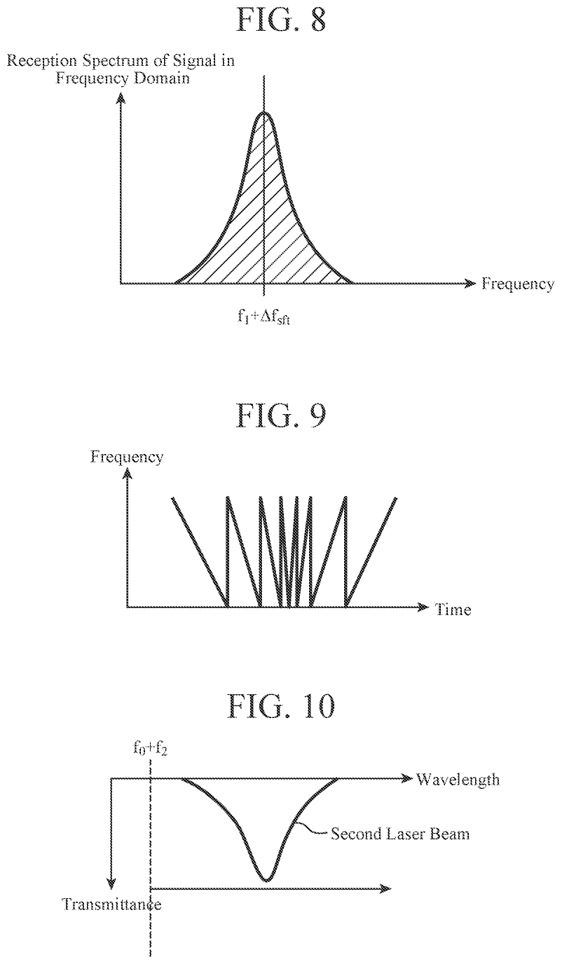

The processing of calculating the intensity of the reception spectrum is disclosed in Non-Patent Literature 2 below, for example. Therefore, although the details of the processing of calculating the intensity of the reception spectrum are omitted, the intensity of the reception spectrum can be calculated from the area of the reception spectrum at the frequency f₁+Δf_{sft} as illustrated in FIG. 8.

FIG. 8 is an explanatory diagram illustrating an area of a reception spectrum.

In FIG. 8, a hatched region indicates the area of the reception spectrum.

[Non-Patent Literature 2]

M. Imaki et al., “Wavelength selection and measurement error theoretical analysis based on ground-based coherent differential absorption lidar using 1.53 μm wavelength for simultaneous vertical profiling of water vapor density and wind speed”, Applied optics vol. 59 No. 8 (2020), 2238-2247.

If the lidar device 1 and the scatterer or the like are away from each other, the spectrum intensity calculating unit 52 calculates the intensity of the reception spectrum at the frequency f₁−Δf_{sft} for each distance range (step ST3 in FIG. 5).

Also in this case, the intensity of the reception spectrum can be calculated from the area of the reception spectrum at the frequency f₁−Δf_{sft}.

If the lidar device 1 does not move and the scatterer or the like does not move, the spectrum intensity calculating unit 52 calculates the intensity of the reception spectrum at the frequency f₁ for each distance range (step ST3 in FIG. 5).

Also in this case, the intensity of the reception spectrum can be calculated from the area of the reception spectrum at the frequency f₁.

The spectrum intensity calculating unit 52 outputs the intensity of the reception spectrum for each distance range to the density calculation processing unit 53.

Hereinafter, each of the intensity of the reception spectrum at the frequency f₁+Δf_{sft} when the optical multiplexer 37 detects the interference light having the optical frequency f₁+Δf_{sft}, the intensity of the reception spectrum at the frequency f₁−Δf_{sft} when the optical multiplexer detects the interference light having the optical frequency f₁−Δf_{sft}, and the intensity of the reception spectrum at the frequency f₁ when the optical multiplexer detects the interference light having the optical frequency f₁ is referred to as “reception intensity of ON wavelength”. The “ON wavelength” means a wavelength included in an absorption wavelength band of a gas.

Each of the intensity of the reception spectrum at the frequency f₁+Δf_{sft} when the optical multiplexer 37 detects the interference light having the optical frequency f₂+Δf_{sft}, the intensity of the reception spectrum at the frequency f₁−Δf_{sft} when the optical multiplexer detects the interference light having the optical frequency f₂−Δf_{sft}, and the intensity of the reception spectrum at the frequency f₁ when the optical multiplexer detects the interference light having the optical frequency f₂ is referred to as “reception intensity of OFF wavelength”. The “OFF wavelength” means a wavelength not included in the absorption wavelength band of the gas.

The density calculation processing unit 53 acquires the intensity of the reception spectrum for each distance range from the spectrum intensity calculating unit 52.

The density calculation processing unit 53 calculates the density of the gas from the intensity of the reception spectrum for each distance range (step ST4 in FIG. 5).

That is, the density calculation processing unit 53 calculates the density n(z) of the gas by substituting the reception intensity of the ON wavelength and the reception intensity of the OFF wavelength related to the scatterer present at the position of the distance z from the lidar device 1 and the reception intensity of the ON wavelength and the reception intensity of the OFF wavelength related to the scatterer present at the position of the distance z+Δz from the lidar device 1 into the following Formula (2).

$$n ( z ) = \frac{1}{2 \cdot Δ z \cdot ( {k}_{ON} - {k}_{OFF} )} \cdot ln [ \frac{{P}_{r \_ OFF} ( z + Δ z )}{{P}_{r \_ ON} ( z + Δ z )} \cdot \frac{{P}_{r \_ ON} ( z )}{{P}_{r \_ OFF} ( z )} ] \qquad ( 2 )$$

In Formula (2), P_{r_ON}(z) is the reception intensity of the ON wavelength related to the scatterer present at the position of the distance z from the lidar device 1, and P_{r_OFF}(z) is the reception intensity of the OFF wavelength of the scatterer present at the position of the distance z from the lidar device 1.

P_{r_ON}(Z+Δz) is the reception intensity of the ON wavelength related to the scatterer present at the position of the distance z+Δz from the lidar device 1, and P_{r_OFF}(z+Δz) is the reception intensity of the OFF wavelength related to the scatterer present at the position of the distance z+Δz from the lidar device 1. Δz is a distance between two points in the observation target gas.

k_{ON} is an absorption coefficient of the ON wavelength and is an already-valued coefficient. k_{OFF} is an absorption coefficient of the OFF wavelength, and is an already-valued coefficient. In is a mathematical symbol indicating a logarithmic function with a base of e.

It is assumed that Δz is, for example, a distance between a distance range (1) and a distance range (3).

When the lidar device 1 and the scatterer or the like are close to each other, the intensity of the reception spectrum at the frequency f₁+Δf_{sft} in the distance range (1) and the intensity of the reception spectrum at the frequency f₁+Δf_{sft} in the distance range (3) when the optical multiplexer 37 detects the interference light having the optical frequency f₁+Δf_{sft} are used as the reception intensity of the ON wavelength. As the reception intensity of the OFF wavelength, the intensity of the reception spectrum at the frequency f₁+Δf_{sft} in the distance range (1) and the intensity of the reception spectrum at the frequency f₁+Δf_{sft} in the distance range (3) when the optical multiplexer 37 detects the interference light having the optical frequency f₂+Δf_{sft} are used.

When the lidar device 1 and the scatterer or the like are away from each other, the intensity of the reception spectrum at the frequency f₁−Δf_{sft} in the distance range (1) and the intensity of the reception spectrum at the frequency f₁−Δf_{sft} in the distance range (3) when the optical multiplexer 37 detects the interference light having the optical frequency f₁−Δf_{sft} are used as the reception intensity of the ON wavelength. As the reception intensity of the OFF wavelength, the intensity of the reception spectrum at the frequency f₁−Δf_{sft} in the distance range (1) and the intensity of the reception spectrum at the frequency f₁−Δf_{sft} in the distance range (3) when the optical multiplexer 37 detects the interference light having the optical frequency f₂−Δf_{sft} are used.

When the lidar device 1 does not move and the scatterer or the like does not move, the intensity of the reception spectrum at the frequency f₁ in the distance range (1) and the intensity of the reception spectrum at the frequency f₁ in the distance range (3) when the optical multiplexer 37 detects the interference light having the optical frequency f₁ are used as the reception intensity of the ON wavelength. As the reception intensity of the OFF wavelength, the intensity of the reception spectrum at the frequency f₁ in the distance range (1) and the intensity of the reception spectrum at the frequency f₁ in the distance range (3) when the optical multiplexer 37 detects the interference light having the optical frequency f₂ are used.

In the first embodiment described above, the lidar device 1 is configured to radiate the first laser beam having the wavelength included in the absorption wavelength band of the observation target gas and the second laser beam having a lower absorption rate by the gas than that of the first laser beam to the space where the gas is present. The lidar device 1 includes a light source 11 to output a laser beam, a frequency output unit 12 to output a first frequency or a second frequency different from the first frequency, a reference light output unit 13 to output the laser beam output from the light source 11 as reference light, an optical transmission unit 14 to generate a first laser beam by modulating an optical frequency of the laser beam output from the light source 11 by the first frequency, generate a second laser beam by modulating an optical frequency of the laser beam output from the light source 11 by the second frequency, and radiate each of the first laser beam and the second laser beam into space, and an optical receiving unit 15 to receive, as scattered light, the first laser beam radiated by the optical transmission unit 14 and then scattered by a scatterer floating in the space or the second laser beam radiated by the optical transmission unit and then scattered by the scatterer, and detect interference light between the scattered light and the reference light. Therefore, the lidar device 1 can calculate the density of the gas without including two light sources.

In the lidar device 1 illustrated in FIG. 1, the optical transmission unit 14 includes an optical amplifier 34. However, this is merely an example, and for example, in a case where it is not necessary to radiate a high-intensity laser beam because the distance z+Δz is short, the optical transmission unit 14 may not include the optical amplifier 34.

In the lidar device 1 illustrated in FIG. 1, the optical transmission unit 14 includes a pulse modulator 33. However, this is merely an example, and for example, the optical transmission unit 14 may radiate a laser beam that is continuous light without including the pulse modulator 33.

In the lidar device 1 illustrated in FIG. 1, the second frequency oscillator 22 outputs the frequency Δf to be added to each of the frequency mixer 23 and the frequency mixer 40. As the second frequency oscillator 22, an oscillator capable of changing the frequency Δf to be added may be used, and the second frequency oscillator 22 may change the frequency Δf to be added.

FIG. 9 is an explanatory diagram illustrating an output waveform of the second frequency oscillator 22 capable of changing the frequency Δf to be added.

The horizontal axis in FIG. 9 represents time, and the vertical axis in FIG. 9 represents frequency. FIG. 9 illustrates a state in which the second frequency oscillator 22 changes the frequency Δf to be added with the lapse of time.

In a case where the frequency modulator 32 is implemented by, for example, a modulation element using a lithium niobate crystal, wavelength sweep of the second wavelength of the second laser beam can be performed as illustrated in FIG. 10 by changing the slope of the serrodyne modulation or the frequency modulation amount according to the change of the frequency Δf to be added.

FIG. 10 is an explanatory diagram illustrating a wavelength sweep of the second laser beam.

By performing the wavelength sweep of the second wavelength of the second laser beam, the lidar device 1 illustrated in FIG. 1 can have a function of a wavelength sweep spectrometer as disclosed in Non-Patent Literature 3 below. In FIG. 10, an arrow indicates that the optical frequency f₀+f₂ of the second laser beam is increased by performing the wavelength sweep.

[Non-Patent Literature 3]

M. P. Arroyo and R. K. Hanson, “Absorption measurements of water-vapor concentration, temperature, and line-shape parameters using a tunable InGaAsP diode laser”, Appl. Opt. 32, 6104-6116 (1993)

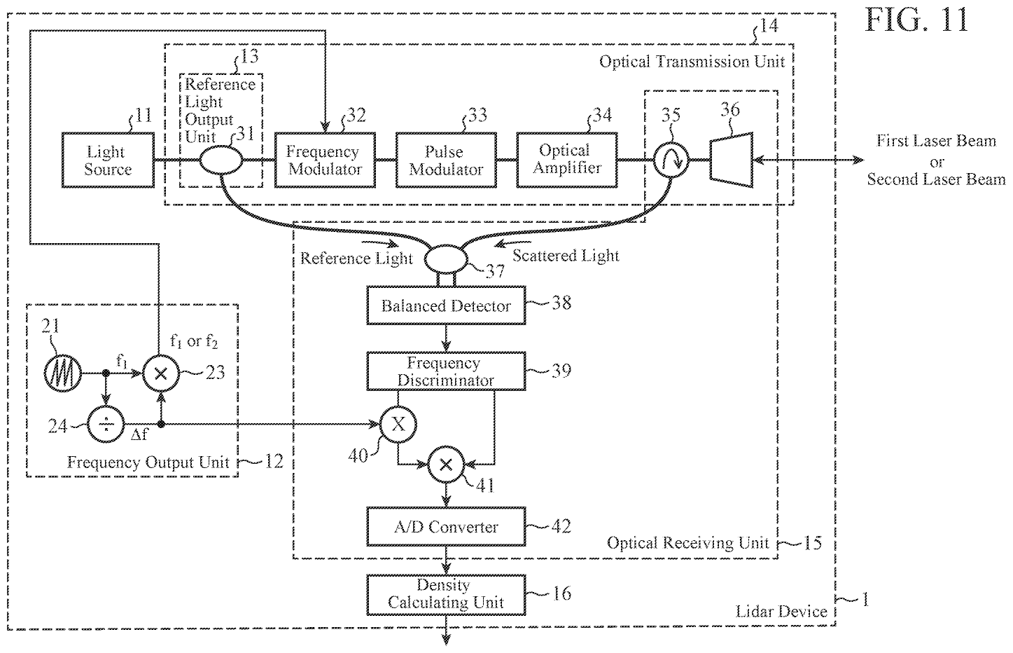

In the lidar device 1 illustrated in FIG. 1, the frequency output unit 12 includes a first frequency oscillator 21, a second frequency oscillator 22, and a frequency mixer 23. However, this is merely an example, and as illustrated in FIG. 11, the frequency output unit 12 may include a frequency conversion unit 24 instead of the second frequency oscillator 22.

FIG. 11 is a configuration diagram illustrating another lidar device 1 according to the first embodiment.

The frequency conversion unit 24 is implemented by, for example, a frequency divider.

The frequency conversion unit 24 converts the first frequency f₁ oscillated by the first frequency oscillator 21 into a frequency Δf to be added, for example, by dividing the first frequency f₁, and outputs the frequency Δf to be added to each of the frequency mixer 23 and the frequency mixer 40.

### Second Embodiment

In the second embodiment, the lidar device 1 in which a frequency output unit 81 outputs a first frequency f₁ and a second frequency f₂ or a third frequency f₃ different from each of the first frequency f₁ and the second frequency f₂ to an optical transmission unit 82 will be described.

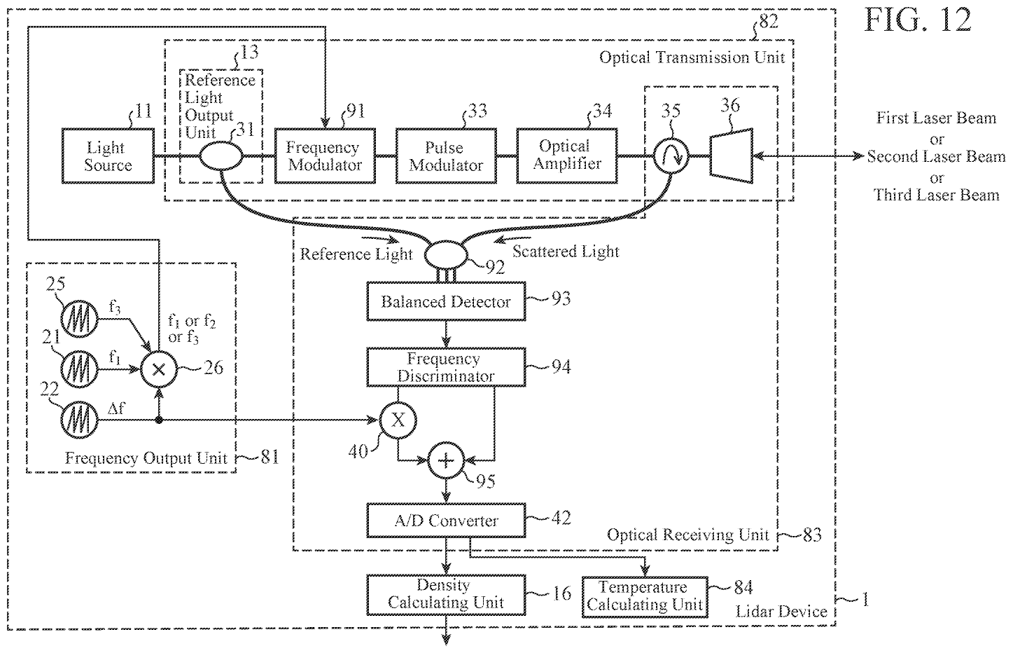

FIG. 12 is a configuration diagram illustrating a lidar device 1 according to the second embodiment. In FIG. 12, the same reference numerals as those in FIG. 1 denote the same or corresponding parts, and thus description thereof is omitted.

The lidar device 1 illustrated in FIG. 12 includes the frequency output unit 81, a reference light output unit 13, the optical transmission unit 82, an optical receiving unit 83, a density calculating unit 16, and a temperature calculating unit 84.

The frequency output unit 81 includes a first frequency oscillator 21, a second frequency oscillator 22, a third frequency oscillator 25, and a frequency mixer 26.

The frequency output unit 81 outputs the first frequency f₁, the second frequency f₂, or the third frequency f₃ to the optical transmission unit 82.

The third frequency oscillator 25 oscillates a third frequency f₃ and outputs the third frequency f₃ to the frequency mixer 26.

The frequency mixer 26 is implemented by, for example, a mixer.

When the frequency Δf to be added is not oscillated by the second frequency oscillator 22, the frequency mixer 26 outputs the first frequency f₁ oscillated by the first frequency oscillator 21 or the third frequency f₃ oscillated by the third frequency oscillator 25 to a frequency modulator 91 to be described later.

When the frequency Δf to be added is oscillated by the second frequency oscillator 22, the frequency mixer 26 outputs the second frequency f₂, which is the frequency f₁+Δf of the sum of the first frequency f₁ oscillated by the first frequency oscillator 21 and the frequency Δf to be added, to the frequency modulator 91.

The optical transmission unit 82 includes an optical distributor 31, a frequency modulator 91, a pulse modulator 33, an optical amplifier 34, an optical circulator 35, and an optical antenna 36.

When the first frequency f₁ is output from the frequency output unit 81, the optical transmission unit 82 generates the first laser beam by modulating the optical frequency f₀ of the laser beam output from the light source 11 by the first frequency f₁, and radiates the first laser beam into space.

When the second frequency f₂ is output from the frequency output unit 81, the optical transmission unit 82 generates the second laser beam by modulating the optical frequency f₀ of the laser beam output from the light source 11 by the second frequency f₂, and radiates the second laser beam into space.

When the third frequency f₃ is output from the frequency output unit 81, the optical transmission unit 82 generates the third laser beam by modulating the optical frequency f₀ of the laser beam output from the light source 11 by the third frequency f₃, and radiates the third laser beam into space. The third laser beam is a laser beam having a third wavelength included in the absorption wavelength band of the observation target gas, and is a laser beam having an absorption rate by the gas different from that of the first laser beam.

The frequency modulator 91 is implemented by, for example, a modulation element using an acousto-optic element or a modulation element using a lithium niobate crystal.

When the first frequency f₁ is output from the frequency mixer 26, the frequency modulator 91 modulates the optical frequency f₀ of the laser beam output from the optical distributor 31 by the first frequency f₁, and outputs the frequency-modulated laser beam to the pulse modulator 33 as the first laser beam. The optical frequency of the first laser beam is f₀+f₁.

When the second frequency f₂ is output from the frequency mixer 26, the frequency modulator 91 modulates the optical frequency f₀ of the laser beam output from the optical distributor 31 by the second frequency f₂, and outputs the laser beam modulated by the second frequency f₂ to the pulse modulator 33 as the second laser beam. The optical frequency of the second laser beam is f₀+f₂.

When the third frequency f₃ is output from the frequency mixer 26, the frequency modulator 91 modulates the optical frequency f₀ of the laser beam output from the optical distributor 31 by the third frequency f₃, and outputs the laser beam modulated by the third frequency f₃ to the pulse modulator 33 as the third laser beam. The optical frequency of the third laser beam is f₀+f₃.

The optical receiving unit 83 includes an optical circulator 35, an optical antenna 36, an optical multiplexer 92, a balanced detector 93, a frequency discriminator 94, a frequency mixer 40, a signal multiplexer 95, and an A/D converter 96.

The optical receiving unit 83 receives, as scattered light, the first laser beam radiated by the optical transmission unit 82 and then scattered by the scatterer floating in the space, the second laser beam radiated by the optical transmission unit and then scattered by the scatterer, or the third laser beam radiated by the optical transmission unit and then scattered by the scatterer, and detects interference light between the scattered light and the reference light.

The optical multiplexer 92 is implemented by, for example, a beam splitter or a fiber type coupler.

The optical multiplexer 92 detects interference light between scattered light output from the optical circulator 35 and reference light output from the optical distributor 31.

The optical multiplexer 92 outputs the interference light to the balanced detector 93.

For example, in a case where the lidar device 1 and the scatterer or the like are close to each other due to the movement of the lidar device 1 or the movement of the gas and the scatterer, the scattered light is subjected to the Doppler shift, and the optical frequencies f₀+f₁, f₀+f₂, and f₀+f₃ of the scattered light are shifted. That is, when the lidar device 1 and the scatterer or the like are close to each other, the optical frequencies f₀+f₁, f₀+f₂, and f₀+f₃ of the scattered light are increased by, for example, the frequency Mgt. If the lidar device 1 and the scatterer or the like are away from each other, the optical frequencies f₀+f₁, f₀+f₂, and f₀+f₃ of the scattered light are lowered by, for example, the frequency Δf_{sft}.

Therefore, when the lidar device 1 and the scatterer or the like are close to each other, the optical multiplexer 92 outputs the interference light having the optical frequency f₁+Δf_{sft} to the balanced detector 93 if the scattered light which is the scattered first laser beam is output from the optical circulator 35, and outputs the interference light having the optical frequency f₂+Δf_{sft} to the balanced detector 93 if the scattered light which is the scattered second laser beam is output from the optical circulator 35. Furthermore, when the lidar device 1 and the scatterer or the like are close to each other, if scattered light that is the scattered third laser beam is output from the optical circulator 35, the optical multiplexer 92 outputs interference light having the optical frequency f₃+Δf_{sft} to the balanced detector 93.

When the lidar device 1 and the scatterer or the like are away from each other, the optical multiplexer 92 outputs the interference light having the optical frequency f₁-Δf_{sft} to the balanced detector 93 if the scattered light which is the scattered first laser beam is output from the optical circulator 35, and outputs the interference light having the optical frequency f₂−Δf_{sft} to the balanced detector 93 if the scattered light which is the scattered second laser beam is output from the optical circulator 35. Furthermore, when the lidar device 1 and the scatterer or the like are away from each other, if scattered light that is the scattered third laser beam is output from the optical circulator 35, the optical multiplexer 92 outputs interference light having the optical frequency f₃-Δf_{sft} to the balanced detector 93.

In addition, when the lidar device 1 does not move and the scatterer or the like does not move, the optical multiplexer 92 outputs the interference light having the optical frequency f₁ to the balanced detector 93 if the scattered light that is the scattered first laser beam is output from the optical circulator 35, and outputs the interference light having the optical frequency f₂ to the balanced detector 93 if the scattered light that is the scattered second laser beam is output from the optical circulator 35. Furthermore, when the lidar device 1 does not move and the scatterer or the like does not move, if the scattered light that is the scattered third laser beam is output from the optical circulator 35, the optical multiplexer 92 outputs the interference light having the optical frequency f₃ to the balanced detector 93.

The balanced detector 93 is implemented by, for example, a balanced receiver that reduces in-phase noise by using two photodiodes.

The balanced detector 93 converts the interference light output from the optical multiplexer 92 into an electric signal.

The balanced detector 93 outputs the electric signal to the frequency discriminator 94.

When the electric signal related to the interference light having the optical frequency f₂+Δf_{sft}, the electric signal related to the interference light having the optical frequency f₂−Δf_{sft}, or the electric signal related to the interference light having the optical frequency f₂ is output from the balanced detector 93, the frequency discriminator 94 outputs these electric signals to the frequency mixer 40.

When the electric signal related to the interference light having the optical frequency f₁+Δf_{sft}, the electric signal related to the interference light having the optical frequency f₁−Δf_{sft}, or the electric signal related to the interference light having the optical frequency f₁ is output from the balanced detector 93, the frequency discriminator 94 outputs these electric signals to the signal multiplexer 95.

In addition, when the electric signal related to the interference light having the optical frequency f₃+Δf_{sft}, the electric signal related to the interference light having the optical frequency f₃−Δf_{sft}, or the electric signal related to the interference light having the optical frequency f₃ is output from the balanced detector 93, the frequency discriminator 94 outputs these electric signals to the signal multiplexer 95.

Upon receiving the electric signal from the frequency discriminator 94, the signal multiplexer 95 outputs the electric signal to the A/D converter 96.

Upon receiving the electric signal from the frequency mixer 40, the signal multiplexer 95 outputs the electric signal to the A/D converter 96.

The A/D converter 96 converts the analog electric signal output from the signal multiplexer 95 into a digital signal.

The A/D converter 96 outputs the digital signal to each of the density calculating unit 16 and the temperature calculating unit 84.

The temperature calculating unit 84 analyzes the optical frequency of the interference light detected by the optical receiving unit 83, and calculates the temperature of the gas from the analysis result of the optical frequency.

The lidar device 1 illustrated in FIG. 12 includes the temperature calculating unit 84. However, this is merely an example, and the lidar device 1 may not include the temperature calculating unit 84, and a computer or the like different from the lidar device 1 may implement the temperature calculating unit 84. In this case, the A/D converter 96 outputs the digital signal to a computer or the like different from the lidar device 1.

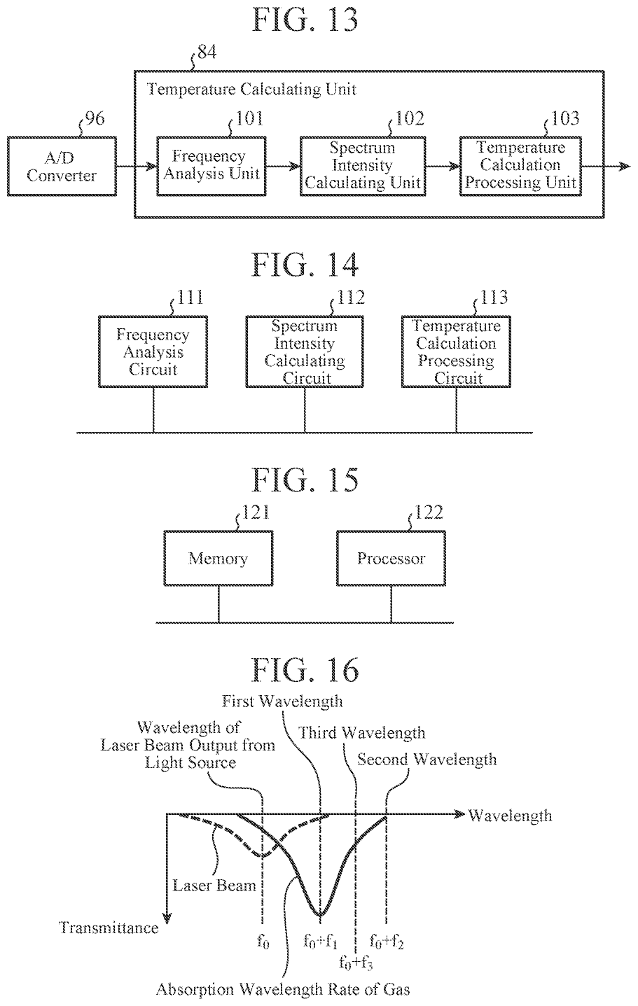

FIG. 13 is a configuration diagram illustrating the temperature calculating unit 84 of the lidar device 1 according to the second embodiment.

FIG. 14 is a hardware configuration diagram illustrating hardware of the temperature calculating unit 84 of the lidar device 1 according to the second embodiment.

The temperature calculating unit 84 illustrated in FIG. 13 includes a frequency analysis unit 101, a spectrum intensity calculating unit 102, and a temperature calculation processing unit 103.

The frequency analysis unit 101 is implemented by, for example, a frequency analysis circuit 111 illustrated in FIG. 14.

The frequency analysis unit 101 converts the digital signal output from the A/D converter 96 into a signal in a frequency domain by performing fast Fourier transform on the digital signal for each predetermined time gate.

The frequency analysis unit 101 outputs the signal in the frequency domain for a plurality of distance ranges to the spectrum intensity calculating unit 102.

The spectrum intensity calculating unit 102 is implemented by, for example, a spectrum intensity calculating circuit 112 illustrated in FIG. 14.

The spectrum intensity calculating unit 102 calculates the intensity of the reception spectrum for each distance range from the signal in the frequency domain for each distance range output from the frequency analysis unit 101.

The spectrum intensity calculating unit 102 calculates the intensity of the reception spectrum for each distance range from the signal in the frequency domain for each distance range output from the frequency analysis unit 101.

That is, when the interference light having the optical frequency f₁+Δf_{sft} or the interference light having the optical frequency f₂+Δf_{sft} is detected by the optical multiplexer 92, the spectrum intensity calculating unit 102 calculates the intensity of the reception spectrum at the frequency f₁+Δf_{sft} for each distance range.

When the interference light having the optical frequency f₃+Δf_{sft} is detected by the optical multiplexer 92, the spectrum intensity calculating unit 102 calculates the intensity of the reception spectrum at the frequency f₃+Δf_{sft} for each distance range.

When the interference light having the optical frequency f₁−Δf_{sft} or the interference light having the optical frequency f₂−Δf_{sft} is detected by the optical multiplexer 92, the spectrum intensity calculating unit 102 calculates the intensity of the reception spectrum at the frequency f₁−Δf_{sft} for each distance range.

When the interference light having the optical frequency f₃−Δf_{sft} is detected by the optical multiplexer 92, the spectrum intensity calculating unit 102 calculates the intensity of the reception spectrum at the frequency f₃−Δf_{sft} for each distance range.

When the interference light having the optical frequency f₁ or the interference light having the optical frequency f₂ is detected by the optical multiplexer 92, the spectrum intensity calculating unit 102 calculates the intensity of the reception spectrum at the frequency f₁ for each distance range.

When the interference light having the optical frequency f₃ is detected by the optical multiplexer 92, the spectrum intensity calculating unit 102 calculates the intensity of the reception spectrum at the frequency f₃ for each distance range.

The spectrum intensity calculating unit 102 outputs the intensity of the reception spectrum for each distance range to the temperature calculation processing unit 103.

The temperature calculation processing unit 103 is implemented by, for example, a temperature calculation processing circuit 113 illustrated in FIG. 14.

The temperature calculation processing unit 103 calculates the temperature of the gas from the intensity of the reception spectrum for each distance range output from the spectrum intensity calculating unit 102.

In FIG. 13, it is assumed that each of the frequency analysis unit 101, the spectrum intensity calculating unit 102, and the temperature calculation processing unit 103, which are components of the temperature calculating unit 84, is implemented by dedicated hardware as illustrated in FIG. 14. That is, it is assumed that the temperature calculating unit 84 is implemented by the frequency analysis circuit 111, the spectrum intensity calculating circuit 112, and the temperature calculation processing circuit 113.

Each of the frequency analysis circuit 111, the spectrum intensity calculating circuit 112, and the temperature calculation processing circuit 113 corresponds to, for example, a single circuit, a composite circuit, a programmed processor, a parallel-programmed processor, ASIC, FPGA, or a combination thereof.

The components of the temperature calculating unit 84 are not limited to those implemented by dedicated hardware, and the temperature calculating unit 84 may be implemented by software, firmware, or a combination of software and firmware.

The software or firmware is stored in a memory of a computer as a program. The computer means hardware that executes a program, and corresponds to, for example, a CPU, a central processing unit, a processing unit, an arithmetic unit, a microprocessor, a microcomputer, a processor, or a DSP.

FIG. 15 is a hardware configuration diagram of a computer in a case where the temperature calculating unit 84 is implemented by software, firmware, or the like.

In a case where the temperature calculating unit 84 is implemented by software, firmware, or the like, a program for causing a computer to execute each processing procedure in the frequency analysis unit 101, the spectrum intensity calculating unit 102, and the temperature calculation processing unit 103 is stored in the memory 121. Then, a processor 122 of the computer executes the program stored in the memory 121.

In addition, FIG. 14 illustrates an example in which each of the components of the temperature calculating unit 84 is implemented by dedicated hardware, and FIG. 15 illustrates an example in which the temperature calculating unit 84 is implemented by software, firmware, or the like. However, this is merely an example, and some components in the temperature calculating unit 84 may be implemented by dedicated hardware, and the remaining components may be implemented by software, firmware, or the like.

Next, the operation of the lidar device 1 illustrated in FIG. 12 will be described.

As in the first embodiment, the light source 11 outputs the laser beam to the optical distributor 31.

The frequency output unit 81 outputs the first frequency f₁, the second frequency f₂, or the third frequency f₃ to the optical transmission unit 82. For example, the frequency output unit 81 sequentially outputs the first frequency f₁, the second frequency f₂, and the third frequency f₃ to the optical transmission unit 82.

Hereinafter, the frequency output operation by the frequency output unit 81 will be specifically described.

The first frequency oscillator 21 oscillates a first frequency f₁ and outputs the first frequency f₁ to the frequency mixer 26.

The second frequency oscillator 22 intermittently oscillates a frequency Δf to be added, and intermittently outputs the frequency Δf to be added to each of the frequency mixer 26 and the frequency mixer 40.

The third frequency oscillator 25 oscillates a third frequency f₃ and outputs the third frequency f₃ to the frequency mixer 26.

When the frequency Δf to be added is not oscillated by the second frequency oscillator 22, the frequency mixer 26 outputs the first frequency f₁ oscillated by the first frequency oscillator 21 or the third frequency f₃ oscillated by the third frequency oscillator 25 to the frequency modulator 91.

When the frequency Δf to be added is oscillated by the second frequency oscillator 22, the frequency mixer 26 outputs the frequency f₁+Δf of the sum of the first frequency f₁ and the frequency Δf to be added to the frequency modulator 91 as the second frequency f₂.

Upon receiving the laser beam from the light source 11, the optical distributor 31 distributes the laser beam at a predetermined ratio, as in the first embodiment.

The optical distributor 31 outputs one of the distributed laser beams to the frequency modulator 91 and outputs the other of the distributed laser beams to the optical multiplexer 92.

The frequency modulator 91 acquires the laser beam from the optical distributor 31.

When acquiring the first frequency f₁ from the frequency mixer 26, the frequency modulator 91 modulates the optical frequency f₀ of the laser beam output from the optical distributor 31 by the first frequency f₁.

The frequency modulator 91 outputs the laser beam modulated by the first frequency f₁ to the pulse modulator 33 as a first laser beam. The optical frequency of the first laser beam is f₀+f₁.

When acquiring the second frequency f₂ from the frequency mixer 26, the frequency modulator 91 modulates the optical frequency f₀ of the laser beam by the second frequency f₂.

The frequency modulator 91 outputs the laser beam modulated by the second frequency f₂ to the pulse modulator 33 as a second laser beam. The optical frequency of the second laser beam is f₀+f₂.

When acquiring the third frequency f₃ from the frequency mixer 26, the frequency modulator 91 modulates the optical frequency f₀ of the laser beam by the third frequency f₃.

The frequency modulator 91 outputs the laser beam modulated by the third frequency f₃ to the pulse modulator 33 as a third laser beam. The optical frequency of the third laser beam is f₀+f₃.

FIG. 16 is an explanatory diagram illustrating an absorption wavelength band of gas, a wavelength of a laser beam output from the light source 11, a first wavelength, a second wavelength, and a third wavelength.

In FIG. 16, the horizontal axis represents the wavelength, and the vertical axis represents the transmittance of the laser beam to the gas.

A broken line indicates a laser beam output from the light source 11, and a solid line indicates an absorption wavelength band of gas. The first wavelength is included in the absorption wavelength band of the gas, and the second wavelength is not included in the absorption wavelength band of the gas. In addition, the third wavelength is included in the absorption wavelength band of the gas and is different from the first wavelength. The transmittance of the second wavelength by the gas is larger than each of the transmittance of the first wavelength by the gas and the transmittance of the third wavelength by the gas. That is, the absorption rate of the second wavelength by the gas is smaller than each of the absorption rate of the first wavelength by the gas and the absorption rate of the third wavelength by the gas.

Since the operations of the pulse modulator 33, the optical amplifier 34, the optical circulator 35, and the optical antenna 36 are similar to those of the first embodiment, detailed description thereof will be omitted.

In the lidar device 1 illustrated in FIG. 12, the first laser beam, the second laser beam, or the third laser beam is radiated from the optical antenna 36 to the space.

The optical multiplexer 92 acquires scattered light from the optical circulator 35 and acquires reference light from the optical distributor 31.

The optical multiplexer 92 detects interference light between the scattered light and the reference light.

For example, in a case where the lidar device 1 moves or the gas and the scatterer move, the scattered light is subjected to the Doppler shift, and the optical frequencies f₀+f₁, f₀+f₂, and f₀+f₃ of the scattered light are shifted. That is, when the lidar device 1 and the scatterer or the like are close to each other, the optical frequencies f₀+f₁, f₀+f₂, and f₀+f₃ of the scattered light are increased by, for example, the frequency Mgt. Since the optical frequency of the reference light is f₀, the optical frequencies of the interference light are f₁+Δf_{sft} (=f₀+f₁+Δf_{sft}−f₀), f₂+Δf_{sft} (=f₀+f₂+Δf_{sft}−f₀), and f₃+Δf_{sft} (=f₀+f₃+Δf_{sft}−f₀).

If the lidar device 1 and the scatterer or the like are away from each other, the optical frequencies f₀+f₁, f₀+f₂, and f₀+f₃ of the scattered light are lowered by, for example, the frequency Δf_{sft}. Since the optical frequency of the reference light is f₀, the optical frequencies of the interference light are f₁−Δf_{sft} (=f₀+f₁−Δf_{sft}−f₀), f₂−Δf_{sft} (=f₀+f₂−Δf_{sft}−f₀), and f₃−Δf_{sft} (=f₀+f₃−Δf_{sft}−f₀).

Therefore, when the lidar device 1 and the scatterer or the like are close to each other, if scattered light that is the scattered first laser beam is output from the optical circulator 35, the optical multiplexer 92 outputs interference light having an optical frequency f₁+Δf_{sft} to the balanced detector 93.

When the lidar device 1 and the scatterer or the like are close to each other, if the scattered light that is the scattered second laser beam is output from the optical circulator 35, the optical multiplexer 92 outputs the interference light having the optical frequency f₂+Δf_{sft} to the balanced detector 93.

Furthermore, when the lidar device 1 and the scatterer or the like are close to each other, if scattered light that is the scattered third laser beam is output from the optical circulator 35, the optical multiplexer 92 outputs interference light having the optical frequency f₃+Δf_{sft} to the balanced detector 93.

When the lidar device 1 and the scatterer or the like are away from each other, if the scattered light that is the scattered first laser beam is output from the optical circulator 35, the optical multiplexer 92 outputs the interference light having the optical frequency f₁−Δf_{sft} to the balanced detector 93.

When the lidar device 1 and the scatterer or the like are away from each other, if scattered light that is the scattered second laser beam is output from the optical circulator 35, the optical multiplexer 92 outputs interference light having the optical frequency f₂−Δf_{sft} to the balanced detector 93.

Furthermore, when the lidar device 1 and the scatterer or the like are away from each other, if scattered light that is the scattered third laser beam is output from the optical circulator 35, the optical multiplexer 92 outputs interference light having the optical frequency f₃−Δf_{sft} to the balanced detector 93.

The balanced detector 93 acquires interference light from the optical multiplexer 92 and converts the interference light into an electric signal.

The balanced detector 93 outputs the electric signal to the frequency discriminator 94.

When the frequency discriminator 94 acquires an electric signal related to the interference light having the optical frequency f₂+Δf_{sft}, an electric signal related to the interference light having the optical frequency f₂−Δf_{sft}, or an electric signal related to the interference light having the optical frequency f₂ from the balanced detector 93, the frequency discriminator outputs the acquired electric signal to the frequency mixer 40.

When the frequency discriminator 94 acquires the electric signal related to the interference light having the optical frequency f₁+Δf_{sft}, the electric signal related to the interference light having the optical frequency f₁−Δf_{sft}, or the electric signal related to the interference light having the optical frequency f₁ from the balanced detector 93, the frequency discriminator outputs the acquired electric signal to the signal multiplexer 95.

In addition, when the frequency discriminator 94 acquires an electric signal related to the interference light having the optical frequency f₃+Δf_{sft}, an electric signal related to the interference light having the optical frequency f₃−Δf_{sft}, or an electric signal related to the interference light having the optical frequency f₃ from the balanced detector 93, the frequency discriminator outputs the acquired electric signal to the signal multiplexer 95.

The frequency mixer 40 acquires the frequency Δf (=f₂−f₁) to be added from the second frequency oscillator 22, and acquires the electric signal from the frequency discriminator 94.

When the frequency of the electric signal output from the frequency discriminator 94 is f₂+Δf_{sft}, the frequency mixer 40 down-converts the frequency of the electric signal to f₁+Δf_{sft} using the frequency Δf to be added.

When the frequency of the electric signal output from the frequency discriminator 94 is f₂−Δf_{sft}, the frequency mixer 40 down-converts the frequency of the electric signal to f₁−Δf_{sft} using the frequency Δf to be added.

When the frequency of the electric signal output from the frequency discriminator 94 is f₂, the frequency mixer 40 down-converts the frequency of the electric signal to f₁ using the frequency Δf to be added.

The frequency mixer 40 outputs the down-converted electric signal to the signal multiplexer 95.

Upon receiving the electric signal from the frequency discriminator 94, the signal multiplexer 95 outputs the electric signal to the A/D converter 96.

That is, when acquiring an electric signal having the frequency f₁+Δf_{sft}, an electric signal having the frequency f₁−Δf_{sft}, or an electric signal having the frequency f₁ from the frequency discriminator 94, the signal multiplexer 95 outputs the electric signal having the frequency f₁+Δf_{sft}, the electric signal having the frequency f₁−Δf_{sft}, or the electric signal having the frequency f₁ to the A/D converter 96.

In addition, when the signal multiplexer 95 acquires an electric signal having the frequency f₃+Δf_{sft}, an electric signal having the frequency f₃−Δf_{sft}, or an electric signal having the frequency f₃ from the frequency discriminator 94, the signal multiplexer 95 outputs the electric signal having the frequency f₃+Δf_{sft}, the electric signal having the frequency f₃−Δf_{sft}, or the electric signal having the frequency f₃ to the A/D converter 96.

Upon receiving the electric signal from the frequency mixer 40, the signal multiplexer 95 outputs the electric signal to the A/D converter 96.

That is, when acquiring an electric signal having the frequency f₁+Δf_{sft}, an electric signal having the frequency f₁−Δf_{sft}, or an electric signal having the frequency f₁ from the frequency mixer 40, the signal multiplexer 95 outputs the electric signal having the frequency f₁+Δf_{sft}, the electric signal having the frequency f₁−Δf_{sft}, or the electric signal having the frequency f₁ to the A/D converter 96.

The A/D converter 96 acquires the electric signal from the signal multiplexer 95.

The A/D converter 96 converts an analog electric signal into a digital signal, and outputs the digital signal to each of the density calculating unit 16 and the temperature calculating unit 84.

The density calculating unit 16 acquires the digital signal from the A/D converter 96.

Similarly to the first embodiment, the density calculating unit 16 converts the digital signal into a signal in the frequency domain by performing fast Fourier transform on the digital signal for each predetermined time gate, and analyzes the frequency of the interference light.

The density calculating unit 16 calculates the density of the gas from the analysis result of the frequency.

That is, in the lidar device 1 illustrated in FIG. 12, when the lidar device 1 and the scatterer or the like are close to each other, the density calculating unit 16 calculates the density of the gas from the intensity of the reception spectrum at the frequency f₁+Δf_{sft} when the first laser beam is radiated and the intensity of the reception spectrum at the frequency f₁+Δf_{sft} when the second laser beam is radiated, as in the first embodiment. When the lidar device 1 and the scatterer or the like are away from each other, the density calculating unit 16 calculates the density of the gas from the intensity of the reception spectrum at the frequency f₁−Δf_{sft} when the first laser beam is radiated and the intensity of the reception spectrum at the frequency f₁−Δf_{sft} when the second laser beam is radiated, as in the first embodiment. When the lidar device 1 does not move and the scatterer or the like does not move, the density calculating unit 16 calculates the density of the gas from the intensity of the reception spectrum at the frequency f₁ when the first laser beam is radiated and the intensity of the reception spectrum at the frequency f₁ when the second laser beam is radiated, as in the first embodiment.

However, this is merely an example, and when the lidar device 1 and the scatterer or the like are close to each other, the density calculating unit 16 may calculate the density of the gas from the intensity of the reception spectrum at the frequency f₃+Δf_{sft} which is the reception intensity of the ON wavelength and the intensity of the reception spectrum at the frequency f₁+Δf_{sft} which is the reception intensity of the OFF wavelength. When the lidar device 1 and the scatterer or the like are away from each other, the density calculating unit 16 may calculate the density of the gas from the intensity of the reception spectrum at the frequency f₃−Δf_{sft} which is the reception intensity of the ON wavelength and the intensity of the reception spectrum at the frequency f₁−Δf_{sft} which is the reception intensity of the OFF wavelength. When the lidar device 1 does not move and the scatterer or the like does not move, the density calculating unit 16 may calculate the density of the gas from the intensity of the reception spectrum at the frequency f₃ which is the reception intensity of the ON wavelength and the intensity of the reception spectrum at the frequency f₁ which is the reception intensity of the OFF wavelength.

The frequency analysis unit 101 of the temperature calculating unit 84 acquires a digital signal from the A/D converter 96.

Similarly to the frequency analysis unit 51 of the density calculating unit 16, the frequency analysis unit 101 converts the digital signal into a signal in the frequency domain by performing fast Fourier transform on the digital signal for each predetermined time gate.

The frequency analysis unit 101 outputs the signal in the frequency domain for a distance range corresponding to each time gate to the spectrum intensity calculating unit 102.

The spectrum intensity calculating unit 102 acquires the signal in the frequency domain for each distance range from the frequency analysis unit 101.

When the lidar device 1 and the scatterer or the like are close to each other, if the optical multiplexer 92 detects the interference light having the optical frequency f₁+Δf_{sft}, the spectrum intensity calculating unit 102 detects the reception spectrum of the frequency f₁+Δf_{sft} from the signal in the frequency domain for each distance range. The reception spectrum of the frequency f₁+Δf_{sft} detected by the spectrum intensity calculating unit 102 is a spectrum obtained by converting the digital signal related to the electric signal of the frequency f₁+Δf_{sft} output from the frequency discriminator 94 into a signal in the frequency domain.

In addition, when the lidar device 1 and the scatterer or the like are close to each other, if the optical multiplexer 92 detects the interference light having the optical frequency f₂+Δf_{sft}, the spectrum intensity calculating unit 102 detects the reception spectrum of the frequency f₁+Δf_{sft} from the signal in the frequency domain for each distance range. The reception spectrum at the frequency f₁+Δf_{sft} detected by the spectrum intensity calculating unit 102 is a spectrum obtained by converting the digital signal related to the electric signal having the frequency f₁+Δf_{sft} output from the frequency mixer 40 into a signal in the frequency domain.

When the lidar device 1 and the scatterer or the like are close to each other, if the optical multiplexer 92 detects the interference light having the optical frequency f₃+Δf_{sft}, the spectrum intensity calculating unit 102 detects the reception spectrum of the frequency f₃+Δf_{sft} from the signal in the frequency domain for each distance range.

When the lidar device 1 and the scatterer or the like are away from each other, if the optical multiplexer 92 detects the interference light having the optical frequency f₁−Δf_{sft}, the spectrum intensity calculating unit 102 detects the reception spectrum at the frequency f₁−Δf_{sft} for each distance range. The reception spectrum at the frequency f₁−Δf_{sft} detected by the spectrum intensity calculating unit 102 is a spectrum obtained by converting the digital signal related to the electric signal having the frequency f₁−Δf_{sft} output from the frequency discriminator 94 into a signal in the frequency domain.

In addition, when the lidar device 1 and the scatterer or the like are away from each other, if the optical multiplexer 92 detects the interference light having the optical frequency f₂−Δf_{sft}, the spectrum intensity calculating unit 102 detects the reception spectrum at the frequency f₁−Δf_{sft} for each distance range. The reception spectrum at the frequency f₁−Δf_{sft} detected by the spectrum intensity calculating unit 102 is a spectrum obtained by converting the digital signal related to the electric signal having the frequency f₁−Δf_{sft} output from the frequency mixer 40 into a signal in the frequency domain.

When the lidar device 1 and the scatterer or the like are away from each other, if the optical multiplexer 92 detects the interference light having the optical frequency f₃−Δf_{sft}, the spectrum intensity calculating unit 102 detects the reception spectrum at the frequency f₃−Δf_{sft} from the signal in the frequency domain for each distance range.

When the lidar device 1 does not move and the scatterer or the like does not move, if the optical multiplexer 92 detects the interference light having the optical frequency f₁, the spectrum intensity calculating unit 102 detects the reception spectrum at the frequency f₁ for each distance range. The reception spectrum at the frequency f₁ detected by the spectrum intensity calculating unit 102 is a spectrum obtained by converting the digital signal related to the electric signal having the frequency f₁ output from the frequency discriminator 94 into a signal in the frequency domain.

In addition, when the lidar device 1 does not move and the scatterer or the like does not move, if the optical multiplexer 92 detects the interference light having the optical frequency f₂, the spectrum intensity calculating unit 102 detects the reception spectrum at the frequency f₁ for each distance range. The reception spectrum at the frequency f₁ detected by the spectrum intensity calculating unit 102 is a spectrum obtained by converting the digital signal related to the electric signal having the frequency f₁ output from the frequency mixer 40 into a signal in the frequency domain.

When the lidar device 1 does not move and the scatterer or the like does not move, if the optical multiplexer 92 detects the interference light having the optical frequency f₃, the spectrum intensity calculating unit 102 detects the reception spectrum at the frequency f₃ for each distance range.

When the lidar device 1 and the scatterer or the like are close to each other, the spectrum intensity calculating unit 102 calculates, for each distance range, the intensity of the reception spectrum at the frequency f₁+Δf_{sft} when the first laser beam is radiated, the intensity of the reception spectrum at the frequency f₁+Δf_{sft} when the second laser beam is radiated, and the intensity of the reception spectrum at the frequency f₃+Δf_{sft} when the third laser beam is radiated.

When the lidar device 1 and the scatterer or the like are away from each other, the spectrum intensity calculating unit 102 calculates, for each distance range, the intensity of the reception spectrum at the frequency f₁−Δf_{sft} when the first laser beam is radiated, the intensity of the reception spectrum at the frequency f₁−Δf_{sft} when the second laser beam is radiated, and the intensity of the reception spectrum at the frequency f₃−Δf_{sft} when the third laser beam is radiated.

When the lidar device 1 does not move and the scatterer or the like does not move, the spectrum intensity calculating unit 102 calculates, for each distance range, the intensity of the reception spectrum at the frequency f₁ when the first laser beam is radiated, the intensity of the reception spectrum at the frequency f₁ when the second laser beam is radiated, and the intensity of the reception spectrum at the frequency f₃ when the third laser beam is radiated.

The processing of calculating the intensity of the reception spectrum by the spectrum intensity calculating unit 102 is similar to the processing of calculating the intensity of the reception spectrum by the spectrum intensity calculating unit 52.

The spectrum intensity calculating unit 102 outputs the intensity of the reception spectrum for each distance range to the temperature calculation processing unit 103.

When the lidar device 1 and the scatterer or the like are close to each other, the temperature calculation processing unit 103 acquires, from the spectrum intensity calculating unit 102, the intensity of the reception spectrum at the frequency f₁+Δf_{sft} when the first laser beam is radiated, the intensity of the reception spectrum at the frequency f₁+Δf_{sft} when the second laser beam is radiated, and the intensity of the reception spectrum at the frequency f₃+Δf_{sft} when the third laser beam is radiated, for each distance range.

The temperature calculation processing unit 103 calculates the temperature of the gas from the two intensities of the reception spectra at the frequency f₁+Δf_{sft} and the intensity of the reception spectrum at the frequency f₃+Δf_{sft} for each distance range.

When the lidar device 1 and the scatterer or the like are close to each other, the intensity of the reception spectrum at the frequency f₁+Δf_{sft} which is the reception intensity of the ON wavelength, the intensity of the reception spectrum at the frequency f₁+Δf_{sft} which is the reception intensity of the OFF wavelength, and the intensity of the reception spectrum at the frequency f₃+Δf_{sft} which is the reception intensity of the ON wavelength are used for calculation of the temperature of the gas by the temperature calculation processing unit 103.

When the lidar device 1 and the scatterer or the like are close to each other, the temperature calculation processing unit 103 acquires, from the spectrum intensity calculating unit 102, the intensity of the reception spectrum at the frequency f₁−Δf_{sft} when the first laser beam is radiated, the intensity of the reception spectrum at the frequency f₁−Δf_{sft} when the second laser beam is radiated, and the intensity of the reception spectrum at the frequency f₃−Δf_{sft} when the third laser beam is radiated, for each distance range.

The temperature calculation processing unit 103 calculates the temperature of the gas from the two intensities of the reception spectra at the frequency f₁−Δf_{sft} and the intensity of the reception spectrum at the frequency f₃−Δf_{sft} for each distance range.

When the lidar device 1 and the scatterer or the like are away from each other, the intensity of the reception spectrum at the frequency f₁−Δf_{sft} which is the reception intensity of the ON wavelength, the intensity of the reception spectrum at the frequency f₁−Δf_{sft} which is the reception intensity of the OFF wavelength, and the intensity of the reception spectrum at the frequency f₃−Δf_{sft} which is the reception intensity of the ON wavelength are used for calculation of the temperature of the gas by the temperature calculation processing unit 103.

When the lidar device 1 does not move and the scatterer or the like does not move, the temperature calculation processing unit 103 acquires, from the spectrum intensity calculating unit 102, the intensity of the reception spectrum at the frequency f₁ when the first laser beam is radiated, the intensity of the reception spectrum at the frequency f₁ when the second laser beam is radiated, and the intensity of the reception spectrum at the frequency f₃ when the third laser beam is radiated, for each distance range.

The temperature calculation processing unit 103 calculates the temperature of the gas from the two intensities of the reception spectra at the frequency f₁ and the intensity of the reception spectrum at the frequency f₃ for each distance range.

When the lidar device 1 does not move and the scatterer or the like does not move, the intensity of the reception spectrum at the frequency f₁ which is the reception intensity of the ON wavelength, the intensity of the reception spectrum at the frequency f₁ which is the reception intensity of the OFF wavelength, and the intensity of the reception spectrum at the frequency f₃ which is the reception intensity of the ON wavelength are used for calculation of the temperature of the gas by the temperature calculation processing unit 103.

The processing itself of calculating the temperature of the gas from the three intensities of the reception spectra at the three frequencies is a known technique, and is disclosed in, for example, Non-Patent Literature 4 below. Therefore, details of the processing of calculating the temperature of the gas will be omitted.

[Non-Patent Literature 4]

Shibata, Yasukuni, Chikao Nagasawa, and Makoto Abo. “A direct detection 1.6 μm DIAL with three wavelengths for high accuracy measurements of vertical CO2 concentration and temperature profiles”. Lidar Technologies, Techniques, and Measurements for Atmospheric Remote Sensing IX. Vol. 8894. International Society for Optics and Photonics, 2013.

In the second embodiment described above, the lidar device 1 is configured so that the frequency output unit 81 outputs the first frequency, the second frequency, or the third frequency to the optical transmission unit 82, the optical transmission unit 82 modulates the optical frequency of the laser beam output from the light source 11 by the third frequency when the third frequency is output from the frequency output unit 81, and radiates the laser beam modulated by the third frequency into space as the third laser beam having the wavelength included in the absorption wavelength band, and the optical receiving unit 83 receives the first laser beam scattered by the scatterer, the second laser beam scattered by the scatterer, or the third laser beam scattered by the scatterer as the scattered light, and detects the interference light between the scattered light and the reference light. In addition, the lidar device 1 includes a temperature calculating unit 84 that analyzes the optical frequency of the interference light detected by the optical receiving unit 83 and calculates the temperature of the gas from the analysis result of the optical frequency. Therefore, even in a situation where the relative position between the gas and the lidar device 1 changes or a situation where the distribution of the scatterers floating in the space changes, the lidar device 1 can calculate the temperature of the gas in addition to preventing the degradation of the calculation accuracy in the density of the gas.

In the lidar device 1 illustrated in FIG. 12, the first wavelength and the third wavelength are wavelengths included in the absorption wavelength band of the same gas. However, this is merely an example, and the first wavelength and the third wavelength may be wavelengths included in absorption wavelength bands of different gases. That is, the first wavelength may be a wavelength included in the absorption wavelength band of the first gas, and the third wavelength may be a wavelength included in the absorption wavelength band of the second gas. Note that, the second wavelength is a wavelength that is not included in the absorption wavelength band of the first gas and is not included in the absorption wavelength band of the second gas.

In this case, when the lidar device 1 and the scatterer or the like are close to each other, the density calculating unit 16 calculates the density of the first gas from the intensity of the reception spectrum at the frequency f₁+Δf_{sft} which is the reception intensity of the ON wavelength and the intensity of the reception spectrum at the frequency f₁+Δf_{sft} which is the reception intensity of the OFF wavelength, and calculates the density of the second gas from the intensity of the reception spectrum at the frequency f₃+Δf_{sft} which is the reception intensity of the ON wavelength and the intensity of the reception spectrum at the frequency f₁+Δf_{sft} which is the reception intensity of the OFF wavelength.

When the lidar device 1 and the scatterer or the like are away from each other, the density calculating unit 16 calculates the density of the first gas from the intensity of the reception spectrum at the frequency f₁−Δf_{sft} which is the reception intensity of the ON wavelength and the intensity of the reception spectrum at the frequency f₁−Δf_{sft} which is the reception intensity of the OFF wavelength, and calculates the density of the second gas from the intensity of the reception spectrum at the frequency f₃−Δf_{sft} which is the reception intensity of the ON wavelength and the intensity of the reception spectrum at the frequency f₁−Δf_{sft} which is the reception intensity of the OFF wavelength.

When the lidar device 1 does not move and the scatterer or the like does not move, the density calculating unit 16 calculates the density of the first gas from the intensity of the reception spectrum at the frequency f₁ which is the reception intensity of the ON wavelength and the intensity of the reception spectrum at the frequency f₁ which is the reception intensity of the OFF wavelength, and calculates the density of the second gas from the intensity of the reception spectrum at the frequency f₃ which is the reception intensity of the ON wavelength and the intensity of the reception spectrum at the frequency f₁ which is the reception intensity of the OFF wavelength. As a result, the lidar device 1 illustrated in FIG. 12 can calculate the densities of two different gases.

### Third Embodiment

In the third embodiment, a lidar device 1 in which a reference light output unit 131 includes a frequency modulator 141 in addition to the optical distributor 31 will be described.

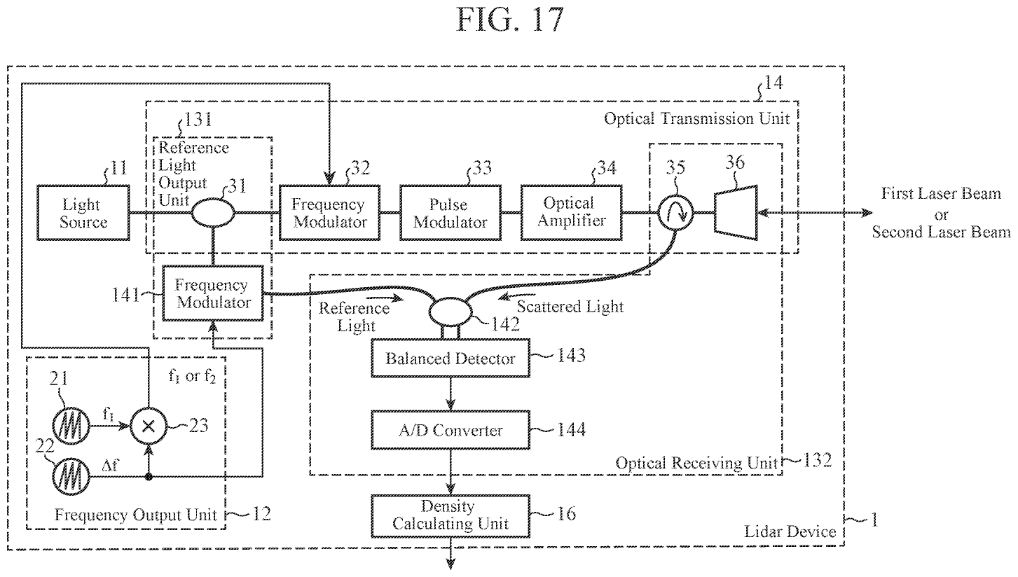

FIG. 17 is a configuration diagram illustrating the lidar device 1 according to the third embodiment. In FIG. 17, the same reference numerals as those in FIG. 1 denote the same or corresponding parts, and thus description thereof is omitted.

The lidar device 1 illustrated in FIG. 17 includes a light source 11, a frequency output unit 12, the reference light output unit 131, an optical transmission unit 14, an optical receiving unit 132, and a density calculating unit 16.

In the lidar device 1 illustrated in FIG. 17, the frequency output unit 12 outputs the first frequency f₁ or the second frequency f₂ to the optical transmission unit 14 as in the first embodiment.

In the lidar device 1 illustrated in FIG. 17, the frequency output unit 12, when outputting the first frequency f₁ to the optical transmission unit 14, does not output the frequency Δf to be added to the reference light output unit 131. The frequency output unit 12, when outputting the second frequency f₂ to the optical transmission unit 14, outputs the frequency Δf to be added to the reference light output unit 131.

The reference light output unit 131 includes an optical distributor 31 and a frequency modulator 141.

When the first frequency f₁ is output from the frequency output unit 12 to the optical transmission unit 14, the reference light output unit 131 outputs the laser beam output from the light source 11 to the optical receiving unit 132 as reference light.

When the second frequency f₂ is output from the frequency output unit 12 to the optical transmission unit 14, the reference light output unit 131 modulates the laser beam output from the light source 11 by the frequency Δf to be added.

The reference light output unit 131 outputs the laser beam modulated by the frequency Δf to be added to the optical receiving unit 132 as reference light.

The frequency modulator 141 is implemented by, for example, a modulation element using an acousto-optic element or a modulation element using a lithium niobate crystal.

When the frequency Δf to be added is not output from the second frequency oscillator 22, the frequency modulator 141 outputs the laser beam output from the optical distributor 31 to the optical multiplexer 142 as reference light. The optical frequency of the reference light is f₀.

When the frequency Δf to be added is output from the second frequency oscillator 22, the frequency modulator 141 modulates the laser beam output from the optical distributor 31 by the frequency Δf to be added.

The frequency modulator 141 outputs the laser beam modulated by the frequency Δf to be added to the optical multiplexer 142 as reference light. The optical frequency of the reference light is f₀+Δf (=f₀+f₂−f₁).

The optical receiving unit 132 includes an optical circulator 35, an optical antenna 36, an optical multiplexer 142, a balanced detector 143, and an A/D converter 144.

The optical receiving unit 132 receives, as scattered light, the first laser beam radiated from the optical transmission unit 14 and then scattered by the scatterer floating in the space or the second laser beam radiated from the optical transmission unit and then scattered by the scatterer, and detects interference light between the scattered light and the reference light.

The optical multiplexer 142 is implemented by, for example, a beam splitter or a fiber type coupler.

The optical multiplexer 142 detects interference light between scattered light output from the optical circulator 35 and reference light output from the frequency modulator 141.

The optical multiplexer 142 outputs the interference light to the balanced detector 143.

When the lidar device 1 and the scatterer or the like are close to each other, if scattered light that is the scattered first laser beam is output from the optical circulator 35, the optical multiplexer 142 outputs interference light having an optical frequency f₁+Δf_{sft} to the balanced detector 143 since the optical frequency of the reference light is f₀.

Furthermore, when the lidar device 1 and the scatterer or the like are close to each other, if scattered light that is the scattered second laser beam is output from the optical circulator 35, the optical multiplexer 142 outputs interference light having the optical frequency f₁+Δf_{sft} to the balanced detector 143 since the optical frequency of the reference light is f₀+f₂−f₁.

When the lidar device 1 and the scatterer or the like are away from each other, if scattered light that is the scattered first laser beam is output from the optical circulator 35, the optical multiplexer 142 outputs interference light having the optical frequency f₁−Δf_{sft} to the balanced detector 143 since the optical frequency of the reference light is f₀.

Furthermore, when the lidar device 1 and the scatterer or the like are away from each other, if scattered light that is the scattered second laser beam is output from the optical circulator 35, the optical multiplexer 142 outputs interference light having the optical frequency f₁−Δf_{sft} to the balanced detector 143 since the optical frequency of the reference light is f₀+f₂-f₁.

When the lidar device 1 does not move and the scatterer or the like does not move, if scattered light that is the scattered first laser beam is output from the optical circulator 35, the optical multiplexer 142 outputs the interference light having the optical frequency f₁ to the balanced detector 143 since the optical frequency of the reference light is f₀.

Furthermore, when the lidar device 1 does not move and the scatterer or the like does not move, if scattered light that is the scattered second laser beam is output from the optical circulator 35, the optical multiplexer 142 outputs interference light of the optical frequency f₁ to the balanced detector 143 since the optical frequency of the reference light is f₀+f₂-f₁.

The balanced detector 143 is implemented by, for example, a balanced receiver that reduces in-phase noise by using two photodiodes.

The balanced detector 143 converts the interference light output from the optical multiplexer 142 into an electric signal.

The balanced detector 143 outputs the electric signal to the A/D converter 144.

The A/D converter 144 converts the analog electric signal output from the balanced detector 143 into a digital signal.

The A/D converter 144 outputs the digital signal to the density calculating unit 16.

Next, the lidar device 1 illustrated in FIG. 17 will be described.

The light source 11 outputs the laser beam to the optical distributor 31. The frequency output unit 12 outputs the first frequency f₁ or the second frequency f₂ to the optical transmission unit 14. For example, the frequency output unit 12 alternately outputs the first frequency f₁ and the second frequency f₂ to the optical transmission unit 14.

Hereinafter, the frequency output operation by the frequency output unit 12 will be specifically described.

The first frequency oscillator 21 oscillates a first frequency f₁ and outputs the first frequency f₁ to the frequency mixer 23.

The second frequency oscillator 22 intermittently oscillates the frequency Δf to be added, and intermittently outputs the frequency Δf to be added to the frequency mixer 23.

The second frequency oscillator 22, when outputting the frequency Δf to be added to the frequency mixer 23, outputs the frequency Δf to be added to the frequency modulator 141.

The second frequency oscillator 22, when not outputting the frequency Δf to be added to the frequency mixer 23, does not output the frequency Δf to be added to the frequency modulator 141.

When the frequency Δf to be added is not output from the second frequency oscillator 22, the frequency mixer 23 outputs the first frequency f₁ oscillated by the first frequency oscillator 21 to the frequency modulator 32.

When the frequency Δf to be added is output from the second frequency oscillator 22, the frequency mixer 23 outputs the frequency f₁+Δf of the sum of the first frequency f₁ and the frequency Δf to be added to the frequency modulator 32 as the second frequency f₂.

Upon receiving the laser beam from the light source 11, the optical distributor 31 distributes the laser beam at a predetermined ratio. The predetermined ratio is, for example, a ratio of 90 on the frequency modulator 32 side and a ratio of 10 on the frequency modulator 141 side.

The optical distributor 31 outputs one of the distributed laser beams to the frequency modulator 32 and outputs the other of the distributed laser beams to the frequency modulator 141.

Since the operations of the frequency modulator 32, the pulse modulator 33, the optical amplifier 34, the optical circulator 35, and the optical antenna 36 are similar to those in the first embodiment, detailed description thereof will be omitted.

The first laser beam or the second laser beam is radiated from the optical antenna 36 to a space where gas is present. The first laser beam scattered by the scatterer floating in the space or the second laser beam scattered by the scatterer is received by the optical antenna 36 as scattered light.

The optical circulator 35 outputs the scattered light received by the optical antenna 36 to the optical multiplexer 142.

When the frequency Δf to be added is not output from the second frequency oscillator 22, the frequency modulator 141 outputs the laser beam output from the light source 11 to the optical multiplexer 142 as reference light. The optical frequency of the reference light is f₀.

When the frequency Δf to be added is output from the second frequency oscillator 22, the frequency modulator 141 modulates the optical frequency f₀ of the laser beam output from the light source 11 by the second frequency f₂.

The frequency modulator 141 outputs the laser beam modulated by the second frequency f₂ to the optical multiplexer 142 as reference light. The optical frequency of the reference light is f₀+f₂.

The optical multiplexer 142 acquires scattered light from the optical circulator 35 and reference light from the frequency modulator 141.

The optical multiplexer 142 detects interference light between scattered light and reference light.

For example, when the lidar device 1 moves or the gas and the scatterer move, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Mgt. When scattered light having an optical frequency of f₀+f₁+Δf_{sft} is acquired from the optical circulator 35, the optical frequency of the interference light is f₁+Δf_{sft} (=f₀+f₁+Δf_{sft}−f₀) because the optical frequency of the reference light output from the frequency modulator 141 is f₀. When scattered light having an optical frequency of f₀+f₂+Δf_{sft} is acquired from the optical circulator 35, the optical frequency of the interference light is f₁+Δf_{sft} (=f₀+f₂+Δf_{sft}−(f₀+f₂−f₁)) because the optical frequency of the reference light output from the frequency modulator 141 is f₀+f₂−f₁.

When the lidar device 1 and the scatterer or the like are away from each other, the optical frequencies f₀+f₁ and f₀+f₂ of the scattered light are decreased by, for example, the frequency Δf_{sft}. When scattered light having an optical frequency of f₀+f₁−Δf_{sft} is acquired from the optical circulator 35, the optical frequency of the interference light is f₁−Δf_{sft} (=f₀+f₁−Δf_{sft}−f₀) because the optical frequency of the reference light output from the frequency modulator 141 is f₀. When scattered light having an optical frequency of f₀+f₂−Δf_{sft} is acquired from the optical circulator 35, the optical frequency of the interference light is f₁−Δf_{sft} (=f₀+f₂−Δf_{sft}−(f₀+f₂−f₁)) because the optical frequency of the reference light output from the frequency modulator 141 is f₀+f₂−f₁.

When the lidar device 1 does not move and the scatterer or the like does not move, the optical frequencies f₀+f₁ and f₀+f₂ of the scattered light do not change. Δf_{sft}=0. When scattered light having an optical frequency of f₀+f₁ is acquired from the optical circulator 35, the optical frequency of the interference light is f₁ (=f₀+f₁−f₀) because the optical frequency of the reference light output from the frequency modulator 141 is f₀. When scattered light having an optical frequency of f₀+f₂ is acquired from the optical circulator 35, the optical frequency of the interference light is f₁(=f₀+f₂−(f₀+f₂−f₁)) because the optical frequency of the reference light output from the frequency modulator 141 is f₀+f₂−f₁.

Therefore, when the lidar device 1 and the scatterer or the like are close to each other, if scattered light which is the scattered first laser beam is output from the optical circulator 35, the optical multiplexer 142 outputs interference light having an optical frequency f₁+Δf_{sft} to the balanced detector 143.

Furthermore, when the lidar device 1 and the scatterer or the like are close to each other, if scattered light which is the scattered second laser beam is output from the optical circulator 35, the optical multiplexer 142 outputs interference light having an optical frequency f₁+Δf_{sft} to the balanced detector 143, similarly to when the scattered first laser beam is output.

When the lidar device 1 and the scatterer or the like are away from each other, if the scattered light which is the scattered first laser beam is output from the optical circulator 35, the optical multiplexer 142 outputs the interference light having the optical frequency f₁−Δf_{sft} to the balanced detector 143.

Furthermore, when the lidar device 1 and the scatterer or the like are away from each other, if the scattered light which is the scattered second laser beam is output from the optical circulator 35, the optical multiplexer 142 outputs interference light having an optical frequency f₁−Δf_{sft} to the balanced detector 143, similarly to when the scattered first laser beam is output.

When the lidar device 1 does not move and the scatterer or the like does not move, if the scattered light which is the scattered first laser beam is output from the optical circulator 35, the optical multiplexer 142 outputs the interference light having the optical frequency f₁ to the balanced detector 143.

Furthermore, when the lidar device 1 does not move and the scatterer or the like does not move, if scattered light which is the scattered second laser beam is output from the optical circulator 35, the optical multiplexer 142 outputs interference light having the optical frequency f₁ to the balanced detector 143 similarly to when the scattered first laser beam is output.

The balanced detector 143 acquires interference light from the optical multiplexer 142 and converts the interference light into an electric signal.

The balanced detector 143 outputs the electric signal to the A/D converter 144.

The A/D converter 144 acquires the electric signal from the balanced detector 143.

The A/D converter 144 converts the analog electric signal into a digital signal and outputs the digital signal to the density calculating unit 16.

Upon receiving the digital signal from the A/D converter 144, the density calculating unit 16 calculates the density of the gas.

That is, when the lidar device 1 and the scatterer or the like are close to each other, the density calculating unit 16 calculates the density of the gas by substituting the intensity of the reception spectrum at the frequency f₁+Δf_{sft} when the first laser beam is radiated and the intensity of the reception spectrum at the frequency f₁+Δf_{sft} when the second laser beam is radiated into Formula (2).

When the lidar device 1 and the scatterer or the like are away from each other, the density calculating unit 16 calculates the density of the gas by substituting the intensity of the reception spectrum at the frequency f₁−Δf_{sft} when the first laser beam is radiated and the intensity of the reception spectrum at the frequency f₁−Δf_{sft} when the second laser beam is radiated into Formula (2).

When the lidar device 1 does not move and the scatterer or the like does not move, the density calculating unit 16 calculates the density of the gas by substituting the intensity of the reception spectrum at the frequency f₁ when the first laser beam is radiated and the intensity of the reception spectrum at the frequency f₁ when the second laser beam is radiated into Formula (2).

Also in the lidar device 1 illustrated in FIG. 17, similarly to the lidar device 1 illustrated in FIG. 1, the density of the gas can be calculated without including two light sources.

In the lidar device 1 illustrated in FIG. 17, the frequency discriminator 39, the frequency mixer 40, and the signal multiplexer 41 are unnecessary.

In the lidar device 1 illustrated in FIG. 17, the frequency modulator 141 is used in the lidar device 1 illustrated in FIG. 1. However, this is merely an example, and the frequency modulator 141 may be used in the lidar device 1 illustrated in FIG. 11 or the lidar device 1 illustrated in FIG. 12.

In the lidar device 1 illustrated in FIG. 17, the frequency mixer 23 of the frequency output unit 12 outputs the first frequency f₁ or the second frequency f₂ to the frequency modulator 32 of the optical transmission unit 14. In addition, only when the second frequency oscillator 22 of the frequency output unit 12 outputs the frequency Δf to be added to the frequency mixer 23, the second frequency oscillator 22 outputs the frequency Δf to be added to the frequency modulator 141 of the reference light output unit 131.

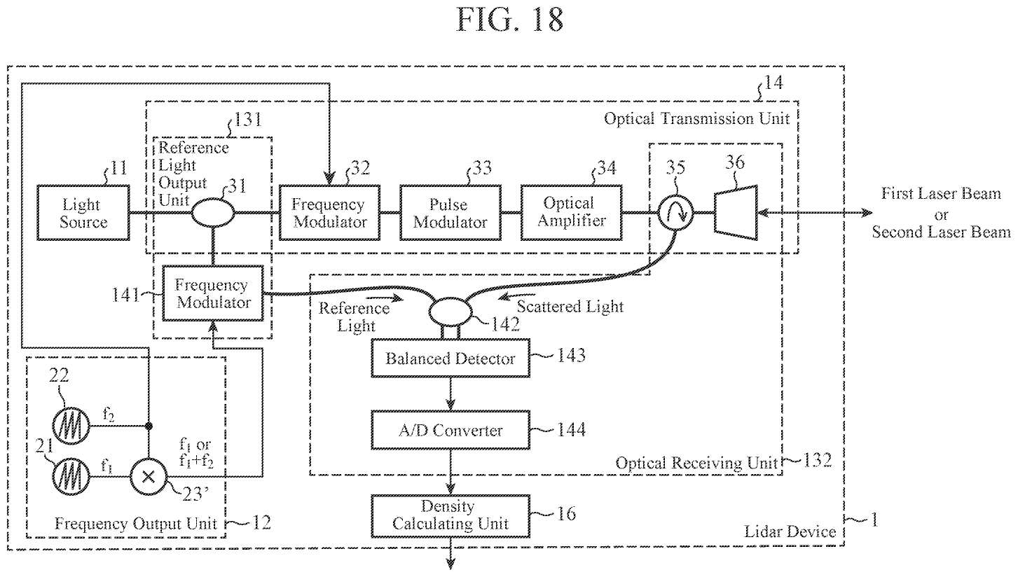

However, this is merely an example, and as illustrated in FIG. 18, the second frequency oscillator 22 of the frequency output unit 12 may intermittently output the second frequency f₂ to the frequency modulator 32, and the frequency mixer 23′ may output the first frequency f₁ or the frequency f₁+f₂ which is the sum of the first frequency f₁ and the second frequency f₂ to the frequency modulator 141.

FIG. 18 is a configuration diagram illustrating another lidar device 1 according to the third embodiment.

In the lidar device 1 illustrated in FIG. 18, the frequency output unit 12 includes a first frequency oscillator 21, a second frequency oscillator 22, and a frequency mixer 23′.

The second frequency oscillator 22 intermittently oscillates the second frequency f₂, and intermittently outputs the second frequency f₂ to each of the frequency modulator 32 and the frequency mixer 23′. When the second frequency f₂ is not output from the second frequency oscillator 22, the frequency mixer 23′ outputs the first frequency f₁ oscillated by the first frequency oscillator 21 to the frequency modulator 141. When the second frequency f₂ is output from the second frequency oscillator 22, the frequency mixer 23′ outputs the frequency f₁+f₂, which is the sum of the first frequency f₁ and the second frequency f₂, to the frequency modulator 141.

In the lidar device 1 illustrated in FIG. 18, when the second frequency f₂ is not output from the second frequency oscillator 22, the frequency modulator 32 of the optical transmission unit 14 does not modulate the optical frequency f₀ of the laser beam output from the optical distributor 31 by the first frequency f₁, and outputs the laser beam to the pulse modulator 33 as the first laser beam. When the second frequency f₂ is output from the second frequency oscillator 22, the frequency modulator 32 generates the second laser beam by modulating the optical frequency f₀ of the laser beam output from the optical distributor 31 by the second frequency f₂, and outputs the second laser beam to the pulse modulator 33.

In the lidar device 1 illustrated in FIG. 18, it is assumed that the wavelength of the laser beam output from the light source 11 is included in the absorption wavelength band of the gas. In addition, it is assumed that the second laser beam generated by modulating by the second frequency f₂ has a lower absorption rate by gas than that of the first laser beam.

When the first frequency f₁ is output from the frequency mixer 23′, the frequency modulator 141 of the reference light output unit 131 modulates the optical frequency f₀ of the laser beam output from the optical distributor 31 by the first frequency f₁, and outputs the laser beam modulated by the first frequency f₁ to the optical multiplexer 142 as reference light.

When the sum frequency f₁+f₂ is output from the frequency mixer 23′, the frequency modulator 141 modulates the optical frequency f₀ of the laser beam output from the optical distributor 31 by the sum frequency f₁+f₂, and outputs the laser beam modulated by the sum frequency f₁+f₂ to the optical multiplexer 142 as reference light.

When the lidar device 1 and the scatterer or the like are close to each other, if the first frequency f₁ is output from the frequency mixer 23′ to the frequency modulator 141, the optical multiplexer 142 acquires the reference light having the optical frequency f₀+f₁ from the frequency modulator 141 and acquires the scattered light having the optical frequency f₀+Δf_{sft} from the optical circulator 35. At this time, the optical frequency of the interference light detected by the optical multiplexer 142 is −f₁+Δf_{sft} (=f₀+Δf_{sft}−(f₀+f₁)).

When the lidar device 1 and the scatterer or the like are close to each other, if the sum frequency f₁+f₂ is output from the frequency mixer 23′ to the frequency modulator 141, the optical multiplexer 142 acquires the reference light having the optical frequency of f₀+f₁+f₂ from the frequency modulator 141 and acquires the scattered light having the optical frequency of f₀+f₂+Δf_{sft} from the optical circulator 35. At this time, the optical frequency of the interference light detected by the optical multiplexer 142 is +Δf_{sft} (=f₀+f₂+Δf_{sft}−(f₀+f₁+f₂)).

When the lidar device 1 and the scatterer or the like are away from each other, if the first frequency f₁ is output from the frequency mixer 23′ to the frequency modulator 141, the optical multiplexer 142 acquires the reference light having the optical frequency f₀+f₁ from the frequency modulator 141 and acquires the scattered light having the optical frequency f₀−Δf_{sft} from the optical circulator 35. At this time, the optical frequency of the interference light detected by the optical multiplexer 142 is −f₁−Δf_{sft} (=f₀−Δf_{sft}−(f₀+f₁)).

When the lidar device 1 and the scatterer or the like are away from each other, if the sum frequency f₁+f₂ is output from the frequency mixer 23′ to the frequency modulator 141, the optical multiplexer 142 acquires the reference light having the optical frequency f₀+f₁+f₂ from the frequency modulator 141 and acquires the scattered light having the optical frequency f₀+f₂−Δf_{sft} from the optical circulator 35. At this time, the optical frequency of the interference light detected by the optical multiplexer 142 is −Δf_{sft} (=f₀+f₂−Δf_{sft}−(f₀+f₁+f₂)).

When the lidar device 1 does not move and the scatterer or the like does not move, if the first frequency f₁ is output from the frequency mixer 23′ to the frequency modulator 141, the optical multiplexer 142 acquires the reference light having the optical frequency f₀+f₁ from the frequency modulator 141 and acquires the scattered light having the optical frequency f₀ from the optical circulator 35. At this time, the optical frequency of the interference light detected by the optical multiplexer 142 is −f₁ (=f₀−(f₀+f₁)).

When the lidar device 1 does not move and the scatterer or the like does not move, if the sum frequency f₁+f₂ is output from the frequency mixer 23′ to the frequency modulator 141, the optical multiplexer 142 acquires the reference light having the optical frequency f₀+f₁+f₂ from the frequency modulator 141 and acquires the scattered light having the optical frequency f₀+f₂ from the optical circulator 35. At this time, the optical frequency of the interference light detected by the optical multiplexer 142 is (=f₀+f₂−(f₀+f₁+f₂)).

The balanced detector 143 acquires interference light from the optical multiplexer 142 and converts the interference light into an electric signal.

The balanced detector 143 outputs the electric signal to the A/D converter 144.

The A/D converter 144 acquires the electric signal from the balanced detector 143.

The A/D converter 144 converts the analog electric signal into a digital signal and outputs the digital signal to the density calculating unit 16.

Upon receiving the digital signal from the A/D converter 144, the density calculating unit 16 calculates the density of the gas.

That is, when the lidar device 1 and the scatterer or the like are close to each other, the density calculating unit 16 calculates the density of the gas by substituting the intensity of the reception spectrum at the frequency+Δf_{sft} when the first laser beam is radiated and the intensity of the reception spectrum at the frequency+Δf_{sft} when the second laser beam is radiated into Formula (2).

When the lidar device 1 and the scatterer or the like are away from each other, the density calculating unit 16 calculates the density of the gas by substituting the intensity of the reception spectrum at the frequency −Δf_{sft} when the first laser beam is radiated and the intensity of the reception spectrum at the frequency −Δf_{sft} when the second laser beam is radiated into Formula (2).

When the lidar device 1 does not move and the scatterer or the like does not move, the density calculating unit 16 calculates the density of the gas by substituting the intensity of the reception spectrum at the frequency when the first laser beam is radiated and the intensity of the reception spectrum at the frequency when the second laser beam is radiated into Formula (2).

### Fourth Embodiment

In a fourth embodiment, a lidar device 1 in which an optical transmission unit 152 radiates a laser beam modulated by a first frequency into space as a first laser beam and radiates a laser beam modulated by a second frequency into space as a second laser beam will be described. That is, the lidar device 1 in which the optical transmission unit 152 simultaneously radiates the first laser beam and the second laser beam to the space will be described.

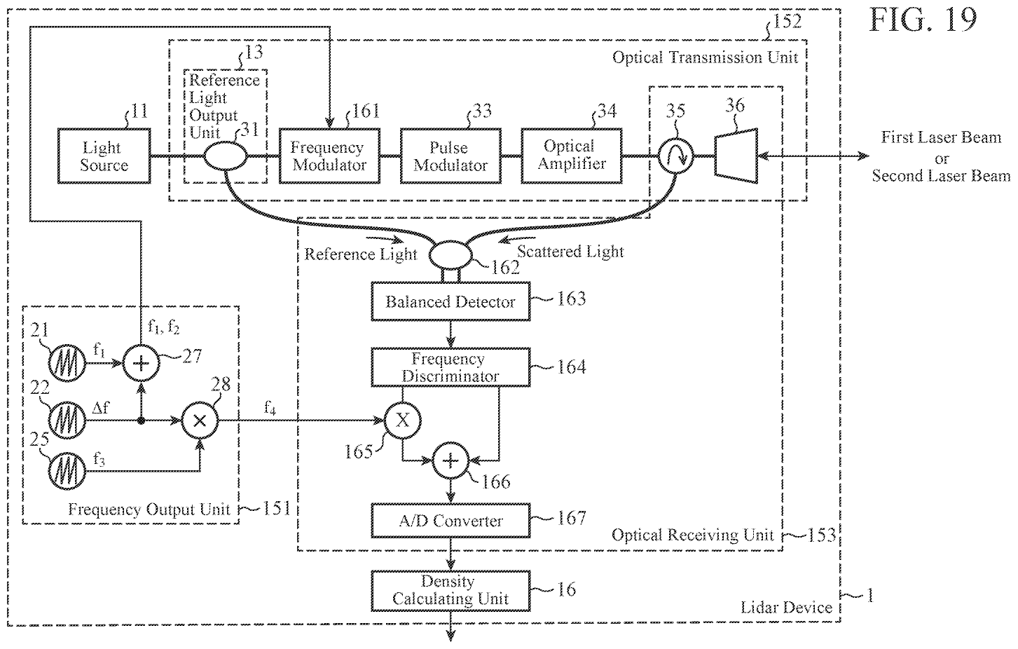

FIG. 19 is a configuration diagram illustrating the lidar device 1 according to the fourth embodiment. In FIG. 19, the same reference numerals as those in FIGS. 1 and 12 denote the same or corresponding parts, and thus description thereof is omitted.

The lidar device 1 illustrated in FIG. 19 includes a light source 11, a frequency output unit 151, a reference light output unit 13, an optical transmission unit 152, an optical receiving unit 153, and a density calculating unit 16.

The frequency output unit 151 includes a first frequency oscillator 21, a second frequency oscillator 22, a third frequency oscillator 25, a signal multiplexer 27, and a frequency conversion unit 28.

The frequency output unit 151 outputs each of the first frequency f₁ and the second frequency f₂ to the optical transmission unit 152.

The first frequency oscillator 21 oscillates a first frequency f₁ and outputs the first frequency f₁ to the signal multiplexer 27.

The second frequency oscillator 22 oscillates a frequency Δf (=f₂−f₁) to be added, and outputs the frequency Δf to be added to each of the signal multiplexer 27 and the frequency conversion unit 28. In the lidar device 1 illustrated in FIG. 19, the second frequency oscillator 22 continuously oscillates the frequency Δf to be added.

The third frequency oscillator 25 oscillates a third frequency f₃ and outputs the third frequency f₃ to the frequency conversion unit 28.

The signal multiplexer 27 calculates a frequency f₁+Δf (=f₂−f₁) of the sum of the first frequency f₁ output from the first frequency oscillator 21 and the frequency Δf to be added output from the second frequency oscillator 22 as a second frequency f₂.

The signal multiplexer 27 outputs both the first frequency f₁ and the second frequency f₂ to a frequency modulator 161 described later.

The frequency conversion unit 28 is implemented by, for example, a mixer.

The frequency conversion unit 28 converts the frequency Δf to be added output from the second frequency oscillator 22 into a frequency Δf+f₃ (=f₂−f₁+f₃) of the sum of the frequency Δf to be added and the third frequency f₃ output from the third frequency oscillator 25.

The frequency conversion unit 28 outputs the sum frequency Δf+f₃ as a fourth frequency f₄ to frequency mixer 165 described later.

The optical transmission unit 152 includes an optical distributor 31, a frequency modulator 161, a pulse modulator 33, an optical amplifier 34, an optical circulator 35, and an optical antenna 36.

The optical transmission unit 152 acquires both the first frequency f₁ and the second frequency f₂ from the frequency output unit 151.

The optical transmission unit 152 modulates the optical frequency f₀ of the laser beam output from the light source 11 by the first frequency f₁, and modulates the optical frequency f₀ of the laser beam output from the light source 11 by the second frequency f₂.

The optical transmission unit 152 radiates the laser beam modulated by the first frequency f₁ into space as a first laser beam, and radiates the laser beam modulated by the second frequency f₂ into space as a second laser beam.

That is, the optical transmission unit 152 simultaneously radiates the first laser beam and the second laser beam to the space where the gas is present.

The frequency modulator 161 is implemented by, for example, a modulation element using an acousto-optic element or a modulation element using a lithium niobate crystal.

The frequency modulator 161 acquires both the first frequency f₁ and the second frequency f₂ from the signal multiplexer 27.

The frequency modulator 161 modulates the optical frequency f₀ of the laser beam output from the light source 11 by the first frequency f₁, and outputs the laser beam after the frequency modulation to the pulse modulator 33 as the first laser beam. The optical frequency of the first laser beam is f₀+f₁.

The frequency modulator 161 modulates the optical frequency f₀ of the laser beam output from the light source 11 by the second frequency f₂, and outputs the laser beam after the frequency modulation to the pulse modulator 33 as the second laser beam. The optical frequency of the second laser beam is f₀+f₂.

The optical receiving unit 153 includes an optical circulator 35, an optical antenna 36, an optical multiplexer 162, a balanced detector 163, a frequency discriminator 164, a frequency mixer 165, a signal multiplexer 166, and an A/D converter 167.

The optical receiving unit 153 receives, as scattered light, each of the first laser beam radiated by the optical transmission unit 152 and then scattered by the scatterer floating in the space and the second laser beam radiated by the optical transmission unit and then scattered by the scatterer, and detects interference light between the scattered light and the reference light.

The optical multiplexer 162 is implemented by, for example, a beam splitter or a fiber type coupler.

The optical multiplexer 162 detects interference light between scattered light output from the optical circulator 35 and reference light output from the optical distributor 31.

The optical multiplexer 162 outputs the interference light to the balanced detector 163.

For example, when the lidar device 1 moves or the gas and the scatterer move, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Mgt. When the lidar device 1 and the scatterer or the like are away from each other, the optical frequencies f₀+f₁ and f₀+f₂ of the scattered light are decreased by, for example, the frequency Δf_{sft}.

Therefore, when the lidar device 1 and the scatterer or the like are close to each other, the optical multiplexer 162 outputs the interference light having the optical frequency f₁+Δf_{sft} to the balanced detector 163 and outputs the interference light having the optical frequency f₂+Δf_{sft} to the balanced detector 163.

When the lidar device 1 and the scatterer or the like are away from each other, the optical multiplexer 162 outputs the interference light having the optical frequency f₁−Δf_{sft} to the balanced detector 163 and outputs the interference light having the optical frequency f₂−Δf_{sft} to the balanced detector 163.

When the lidar device 1 does not move and the scatterer or the like does not move, the optical multiplexer 162 outputs the interference light having the frequency f₁ to the balanced detector 163 and outputs the interference light having the frequency f₂ to the balanced detector 163 since the optical frequencies f₀+f₁ and f₀+f₂ of the scattered light are not shifted.

The balanced detector 163 is implemented by, for example, a balanced receiver that reduces in-phase noise by using two photodiodes.

The balanced detector 163 converts the interference light output from the optical multiplexer 162 into an electric signal.

The balanced detector 163 outputs the electric signal to the frequency discriminator 164.

When the electric signal related to the interference light having the optical frequency f₂+Δf_{sft}, the electric signal related to the interference light having the optical frequency f₂−Δf_{sft}, or the electric signal related to the interference light having the optical frequency f₂ is output from the balanced detector 163, the frequency discriminator 164 outputs these electric signals to the frequency mixer 165.

When the electric signal related to the interference light having the optical frequency f₁+Δf_{sft}, the electric signal related to the interference light having the optical frequency f₁−Δf_{sft}, or the electric signal related to the interference light having the optical frequency f₁ is output from the balanced detector 163, the frequency discriminator 164 outputs these electric signals to the signal multiplexer 166.

The frequency mixer 165 down-converts the frequency of the electric signal output from the frequency discriminator 164 using the fourth frequency f₄ output from the frequency conversion unit 28.

That is, when the frequency of the electric signal output from the frequency discriminator 164 is f₂+Δf_{sft}, the frequency mixer 165 down-converts the frequency of the electric signal to f₂−f₄+Δf_{sft} using the fourth frequency ft.

When the frequency of the electric signal output from the frequency discriminator 164 is f₂−Δf_{sft}, the frequency mixer 165 down-converts the frequency of the electric signal to f₂−f₄−Δf_{sft} using the fourth frequency ft.

When the frequency of the electric signal output from the frequency discriminator 164 is f₂, the frequency mixer 165 down-converts the frequency of the electric signal to f₂−f₄ using the fourth frequency ft.

The frequency mixer 165 outputs the down-converted electric signal to the signal multiplexer 166.

The signal multiplexer 166 multiplexes the electric signal output from the frequency discriminator 164 and the electric signal output from the frequency mixer 165, and outputs the multiplexed electric signal to the A/D converter 167.

The A/D converter 167 converts the analog electric signal output from the signal multiplexer 166 into a digital signal.

The A/D converter 167 outputs the digital signal to the density calculating unit 16.

Next, the lidar device 1 illustrated in FIG. 19 will be described.

The light source 11 outputs the laser beam to the optical distributor 31.

The frequency output unit 151 outputs each of the first frequency f₁ and the second frequency f₂ to the optical transmission unit 152.

Hereinafter, the frequency output operation by the frequency output unit 151 will be specifically described.

The first frequency oscillator 21 oscillates a first frequency f₁ and outputs the first frequency f₁ to the signal multiplexer 27.

The second frequency oscillator 22 oscillates a frequency Δf to be added, and outputs the frequency Δf to be added to each of the signal multiplexer 27 and the frequency conversion unit 28.

The third frequency oscillator 25 oscillates a third frequency f₃ and outputs the third frequency f₃ to the frequency conversion unit 28.

The signal multiplexer 27 acquires the first frequency f₁ from the first frequency oscillator 21 and acquires the frequency Δf (=f₂−f₁) to be added from the second frequency oscillator 22.

The signal multiplexer 27 calculates the frequency f₁+Δf of the sum of the first frequency f₁ and the frequency Δf to be added as the second frequency f₂.

The signal multiplexer 27 outputs both the first frequency f₁ and the second frequency f₂ to the frequency modulator 161.

The frequency conversion unit 28 acquires the frequency Δf to be added from the second frequency oscillator 22 and acquires the third frequency f₃ from the third frequency oscillator 25.

The frequency conversion unit 28 outputs frequency Δf+f₃ which is a sum of the frequency Δf to be added and the third frequency f₃ to the frequency mixer 165 as the fourth frequency ft.

The frequency modulator 161 acquires both the first frequency f₁ and the second frequency f₂ from the signal multiplexer 27.

The frequency modulator 161 modulates the optical frequency f₀ of the laser beam output from the light source 11 by the first frequency f₁, and outputs the laser beam after the frequency modulation to the pulse modulator 33 as the first laser beam. The optical frequency of the first laser beam is f₀+f₁.

The frequency modulator 161 modulates the optical frequency f₀ of the laser beam output from the light source 11 by the second frequency f₂, and outputs the laser beam after the frequency modulation to the pulse modulator 33 as the second laser beam. The optical frequency of the second laser beam is f₀+f₂.

The first laser beam having the optical frequency f₀+f₁ has a first wavelength included in the absorption wavelength band of gas, and the second laser beam having the optical frequency f₀+f₂ has a second wavelength not included in the absorption wavelength band of gas.

Since the operations of the pulse modulator 33, the optical amplifier 34, the optical circulator 35, and the optical antenna 36 are similar to those of the first embodiment, detailed description thereof will be omitted.

In the lidar device 1 illustrated in FIG. 19, the first laser beam and the second laser beam are simultaneously radiated from the optical antenna 36 to the space.

The optical antenna 36 receives each of the first laser beam scattered by the scatterer and the second laser beam scattered by the scatterer as scattered light.

The optical circulator 35 outputs the scattered light received by the optical antenna 36 to the optical multiplexer 162.

The optical multiplexer 162 acquires scattered light from the optical circulator 35 and reference light from the optical distributor 31.

The optical multiplexer 162 detects interference light between scattered light and reference light.

For example, when the lidar device 1 moves or the gas and the scatterer move, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Δf_{sft}. Since the optical frequency of the reference light output from the optical distributor 31 is f₀, the optical frequency of the interference light between the scattered light having the optical frequency f₀+f₁+Δf_{sft} output from the optical circulator 35 and the reference light is f₁+Δf_{sft} (=f₀+f₁+Δf_{sft}−f₀). In addition, the optical frequency of the interference light between the scattered light having the optical frequency f₀+f₂+Δf_{sft} output from the optical circulator 35 and the reference light is f₂+Δf_{sft} (=f₀+f₂+Δf_{sft}−f₀).

When the lidar device 1 and the scatterer or the like are away from each other, the optical frequencies f₀+f₁ and f₀+f₂ of the scattered light are decreased by, for example, the frequency Δf_{sft}. Since the optical frequency of the reference light output from the optical distributor 31 is f₀, the optical frequency of the interference light between the scattered light having the optical frequency f₀+f₁−Δf_{sft} output from the optical circulator 35 and the reference light is f₁−Δf_{sft} (=f₀+f₁−Δf_{sft}−f₀). In addition, the optical frequency of the interference light between the scattered light having the optical frequency f₀+f₂−Δf_{sft} output from the optical circulator 35 and the reference light is f₂−Δf_{sft} (=f₀+f₂−Δf_{sft}−f₀).

When the lidar device 1 does not move and the scatterer or the like does not move, the optical frequencies f₀+f₁ and f₀+f₂ of the scattered light do not change. Δf_{sft}=0. Since the optical frequency of the reference light output from the optical distributor 31 is f₀, the optical frequency of the interference light between the scattered light having the optical frequency f₀+f₁ output from the optical circulator 35 and the reference light is f₁ (=f₀+f₁−f₀). In addition, the optical frequency of the interference light between the scattered light having the optical frequency f₀+f₂ output from the optical circulator 35 and the reference light is f₂ (=f₀+f₂−f₀).

Therefore, when the lidar device 1 and the scatterer or the like are close to each other, the optical multiplexer 162 outputs the interference light having the optical frequency f₁+Δf_{sft} and the interference light having the optical frequency f₂+Δf_{sft} to the balanced detector 163.

When the lidar device 1 and the scatterer or the like are away from each other, the optical multiplexer 162 outputs the interference light having the optical frequency f₁−Δf_{sft} and the interference light having the optical frequency f₂−Δf_{sft} to the balanced detector 163.

When the lidar device 1 does not move and the scatterer or the like does not move, the optical multiplexer 162 outputs the interference light having the optical frequency f₁ and the interference light having the optical frequency f₂ to the balanced detector 163.

The balanced detector 163 acquires interference light from the optical multiplexer 162 and converts the interference light into an electric signal.

The balanced detector 163 outputs the electric signal to the frequency discriminator 164.

When the frequency discriminator 164 acquires an electric signal related to the interference light having the optical frequency f₂+Δf_{sft}, an electric signal related to the interference light having the optical frequency f₂−Δf_{sft}, or an electric signal related to the interference light having the optical frequency f₂ from the balanced detector 163, the frequency discriminator 164 outputs the acquired electric signal to the frequency mixer 165.

When the frequency discriminator 164 acquires the electric signal related to the interference light having the optical frequency f₁+Δf_{sft}, the electric signal related to the interference light having the optical frequency f₁−Δf_{sft}, or the electric signal related to the interference light having the optical frequency f₁ from the balanced detector 163, the frequency discriminator outputs the acquired electric signal to the signal multiplexer 166.

The frequency mixer 165 acquires the fourth frequency f₄ from the second frequency oscillator 22 and acquires the electric signal from the frequency discriminator 164.

If the frequency of the electric signal output from the frequency discriminator 164 is f₂+Δf_{sft}, the frequency mixer 165 down-converts the frequency of the electric signal to f₂−f₄+Δf_{sft} using the fourth frequency f₄.

When the frequency of the electric signal output from the frequency discriminator 164 is f₂−Δf_{sft}, the frequency mixer 165 down-converts the frequency of the electric signal to f₂−f₄−Δf_{sft} using the fourth frequency f₄.

When the frequency of the electric signal output from the frequency discriminator 164 is f₂, the frequency mixer 165 down-converts the frequency of the electric signal to f₂−f₄ using the fourth frequency ft.

The frequency mixer 165 outputs the down-converted electric signal to the signal multiplexer 166.

The signal multiplexer 166 acquires the electric signal from the frequency discriminator 164 and acquires the electric signal from the frequency mixer 165.

The signal multiplexer 166 multiplexes the two electric signals and outputs the multiplexed electric signal to the A/D converter 167.

That is, when the electric signal related to the interference light having the optical frequency f₂+Δf_{sft} is output from the frequency discriminator 164 and the electric signal having the optical frequency f₂−f₄+Δf_{sft} is output from the frequency mixer 165, the signal multiplexer 166 multiplexes these electric signals. The signal multiplexer 166 outputs the electric signal including the frequencies f₂+Δf_{sft} and f₂−f₄+Δf_{sft} to the A/D converter 167 as the multiplexed electric signal.

When the electric signal related to the interference light having the optical frequency f₂−Δf_{sft} is output from the frequency discriminator 164 and the electric signal having the optical frequency f₂−f₄−Δf_{sft} is output from the frequency mixer 165, the signal multiplexer 166 multiplexes these electric signals. The signal multiplexer 166 outputs the electric signal including the frequencies f₂−Δf_{sft} and f₂−f₄−Δf_{sft} to the A/D converter 167 as the multiplexed electric signal.

When the electric signal related to the interference light having the optical frequency f₂ is output from the frequency discriminator 164 and the electric signal having the frequency f₂−f₄ is output from the frequency mixer 165, the signal multiplexer 166 multiplexes these electric signals. The signal multiplexer 166 outputs the electric signal including the frequencies f₂ and f₂−f₄ to the A/D converter 167 as the multiplexed electric signal.

The A/D converter 167 acquires an electric signal from the signal multiplexer 166.

The A/D converter 167 converts the analog electric signal into a digital signal, and outputs the digital signal to the frequency analysis unit 51 of the density calculating unit 16.

The frequency analysis unit 51 of the density calculating unit 16 acquires the digital signal from the A/D converter 167.

The frequency analysis unit 51 converts the digital signal into a signal in the frequency domain by performing fast Fourier transform on the digital signal for each predetermined time gate.

The frequency analysis unit 51 outputs the signal in the frequency domain for a distance range corresponding to each time gate to the spectrum intensity calculating unit 52.

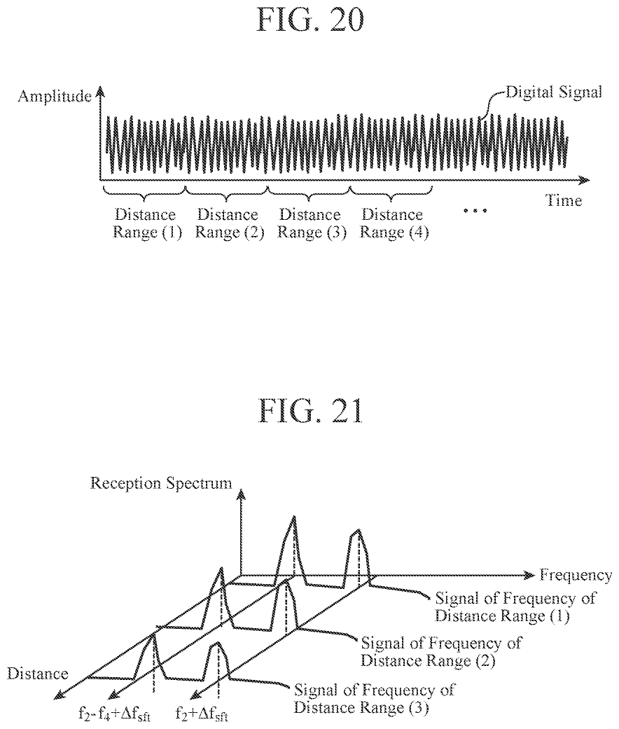

FIG. 20 is an explanatory diagram illustrating a relationship between a digital signal provided to the frequency analysis unit 51 and a distance range corresponding to each time gate.

FIG. 20 illustrates digital signals for the distance range (1), the distance range (2), the distance range (3), the distance range (4), . . . .

The spectrum intensity calculating unit 52 acquires the signal in the frequency domain for each distance range from the frequency analysis unit 51.

When the lidar device 1 and the scatterer or the like are close to each other, the spectrum intensity calculating unit 52 detects the reception spectrum at the frequency f₂+Δf_{sft} and the reception spectrum at the frequency f₂−f₄+Δf_{sft} for each distance range.

When the lidar device 1 and the scatterer or the like are away from each other, the spectrum intensity calculating unit 52 detects the reception spectrum at the frequency f₂−Δf_{sft} and the reception spectrum of the frequency f₂−f₄−Δf_{sft} for each distance range.

When the lidar device 1 does not move and the scatterer or the like does not move, the spectrum intensity calculating unit 52 detects the reception spectrum at the frequency f₂ and the reception spectrum at the frequency f₂−ft.

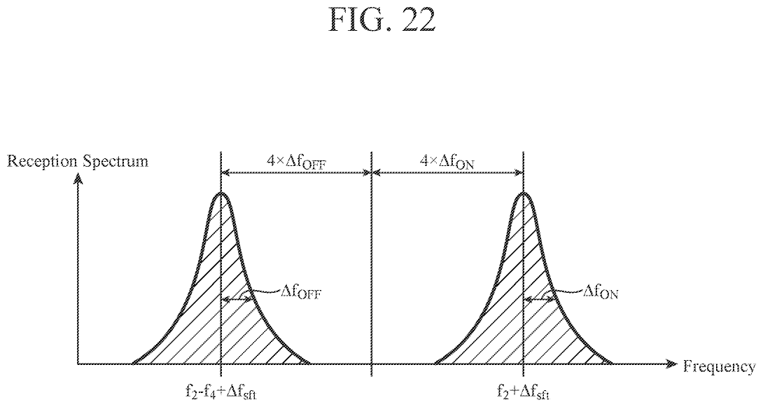

FIG. 21 is an explanatory diagram illustrating a signal in the frequency domain for each distance range and a reception spectrum for each distance range.

FIG. 21 illustrates each of the signals and the reception spectra in the frequency domain for the distance range (1), the distance range (2), and the distance range (3).

FIG. 21 illustrates each of the signal and the reception spectrum in the frequency domain when the lidar device 1 and the scatterer or the like are close to each other.

When the lidar device 1 and the scatterer or the like are close to each other, the spectrum intensity calculating unit 52 calculates the intensity of the reception spectrum at the frequency f₂+Δf_{sft} and the intensity of the reception spectrum at the frequency f₂−f₄+Δf_{sft} for each distance range.

The processing of calculating the intensity of the reception spectrum is disclosed in, for example, Non-Patent Literature 2. Therefore, although the details of the processing of calculating the intensity of the reception spectrum are omitted, the intensity of the reception spectrum can be calculated from the area of the reception spectrum at the frequency f₂+Δf_{sft}, and the intensity of the reception spectrum can be calculated from the area of the reception spectrum at the frequency f₂−f₄+Δf_{sft}.

FIG. 22 is an explanatory diagram illustrating an area of a reception spectrum and a frequency difference between two reception spectra.

In FIG. 22, a hatched region indicates the area of the reception spectrum.

When the lidar device 1 and the scatterer or the like are away from each other, the spectrum intensity calculating unit 52 calculates the intensity of the reception spectrum at the frequency f₂−Δf_{sft} and the intensity of the reception spectrum at the frequency f₂−f₄−Δf_{sft} for each distance range.

Also in this case, the intensity of the reception spectrum can be calculated from the area of the reception spectrum at the frequency f₂−Δf_{sft}, and the intensity of the reception spectrum can be calculated from the area of the reception spectrum at the frequency f₂−f₄−Δf_{sft}.

When the lidar device 1 does not move and the scatterer or the like does not move, the spectrum intensity calculating unit 52 calculates the intensity of the reception spectrum at the frequency f₂ and the intensity of the reception spectrum at the frequency f₂−f₄ for each distance range.

Also in this case, the intensity of the reception spectrum can be calculated from the area of the reception spectrum at the frequency f₂, and the intensity of the reception spectrum can be calculated from the area of the reception spectrum at the frequency f₂−f₄.

The spectrum intensity calculating unit 52 outputs the intensity of the reception spectrum for each distance range to the density calculation processing unit 53.

Hereinafter, each of the intensity of the reception spectrum at the frequency f₂+Δf_{sft}, the intensity of the reception spectrum at the frequency f₂−Δf_{sft}, and the intensity of the reception spectrum at the frequency f₂ is referred to as “reception intensity of ON wavelength”. The “ON wavelength” means a wavelength included in an absorption wavelength band of a gas.

Further, each of the intensity of the reception spectrum at the frequency f₂−f₄+Δf_{sft}, the intensity of the reception spectrum at the frequency f₂−f₄−Δf_{sft}, and the intensity of the reception spectrum at the frequency f₂−f₄ is referred to as “reception intensity of OFF wavelength”. The “OFF wavelength” means a wavelength not included in the absorption wavelength band of the gas.

It is assumed that the distribution of the two reception spectra detected by the spectrum intensity calculating unit 52 is a Gaussian distribution as illustrated in FIG. 22.

Further, as illustrated in FIG. 22, the standard deviation value of one of the two reception spectra is Δf_{ON}, and the standard deviation value of the other reception spectrum is Δf_{OFF}.

At this time, when the frequency difference Δf (=f₄) between f₂ and (f₂−f₄) is equal to or larger than the sum of four times the standard deviation value Δf_{ON} and four times the standard deviation value Δf_{OFF} as expressed in the following Formula (3), the intensities of the two reception spectra can be calculated with 99.99% accuracy.

Δ≥4×Δf_{ON}+4×Δf_{OFF} (3)

For example, when each of the standard deviation value Δf_{ON} and the standard deviation value Δf_{OFF} is 1 MHz, the frequency difference Δf is 8 MHz or more.

Therefore, in the lidar device 1 illustrated in FIG. 19, the frequency output unit 151 outputs each of the first frequency f₁, the second frequency f₂, and the fourth frequency f₄ in which the frequency difference Δf satisfies Formula (3).

The density calculation processing unit 53 acquires the intensity of the reception spectrum for each distance range from the spectrum intensity calculating unit 52.

The density calculation processing unit 53 calculates the density of the gas from the intensity of the reception spectrum for each distance range.

That is, the density calculation processing unit 53 calculates the density n(z) of the gas by substituting the reception intensity of the ON wavelength and the reception intensity of the OFF wavelength at the position of the distance z from the lidar device 1 and the reception intensity of the ON wavelength and the reception intensity of the OFF wavelength at the position of the distance z+Δz from the lidar device 1 into the above Formula (2).

When the lidar device 1 and the scatterer or the like are close to each other, the intensity of the reception spectrum at the frequency f₂+Δf_{sft} is used as the reception intensity of the ON wavelength, and the intensity of the reception spectrum at the frequency f₂−f₄+Δf_{sft} is used as the reception intensity of the OFF wavelength.

When the lidar device 1 and the scatterer or the like are away from each other, the intensity of the reception spectrum at the frequency f₂−Δf_{sft} is used as the reception intensity of the ON wavelength, and the intensity of the reception spectrum at the frequency f₂−f₄−Δf_{sft} is used as the reception intensity of the OFF wavelength.

When the gas is stationary or even when the gas moves, if the distance between the gas and the lidar device 1 does not change, the intensity of the reception spectrum at the frequency f₂ is used as the reception intensity of the ON wavelength, and the intensity of the reception spectrum at the frequencies f₂−f₄ is used as the reception intensity of the OFF wavelength.

In the fourth embodiment described above, the lidar device 1 is configured to radiate the first laser beam having the wavelength included in the absorption wavelength band of the observation target gas and the second laser beam having a lower absorption rate by the gas than that of the first laser beam to the space where the gas is present. In addition, the lidar device 1 includes a light source 11 to output a laser beam;

a frequency output unit 151 to output each of a first frequency and a second frequency; a reference light output unit 13 to output the laser beam output from the light source 11 as reference light; an optical transmission unit 152 to generate the first laser beam by modulating an optical frequency of the laser beam output from the light source 11 by the first frequency, generate the second laser beam by modulating the optical frequency of the laser beam output from the light source 11 by the second frequency, and radiate each of the first laser beam and the second laser beam to the space; and an optical receiving unit 153 to receive, as scattered light, each of the first laser beam radiated by the optical transmission unit 152 and then scattered by a scatterer floating in the space and the second laser beam radiated by the optical transmission unit and then scattered by the scatterer, and detect interference light between the scattered light and the reference light. Therefore, the lidar device 1 can calculate the density of the gas without including two light sources.

### Fifth Embodiment

In a fifth embodiment, the lidar device 1 in which the reference light output unit 171 includes a frequency modulator 181 in addition to the optical distributor 31 will be described.

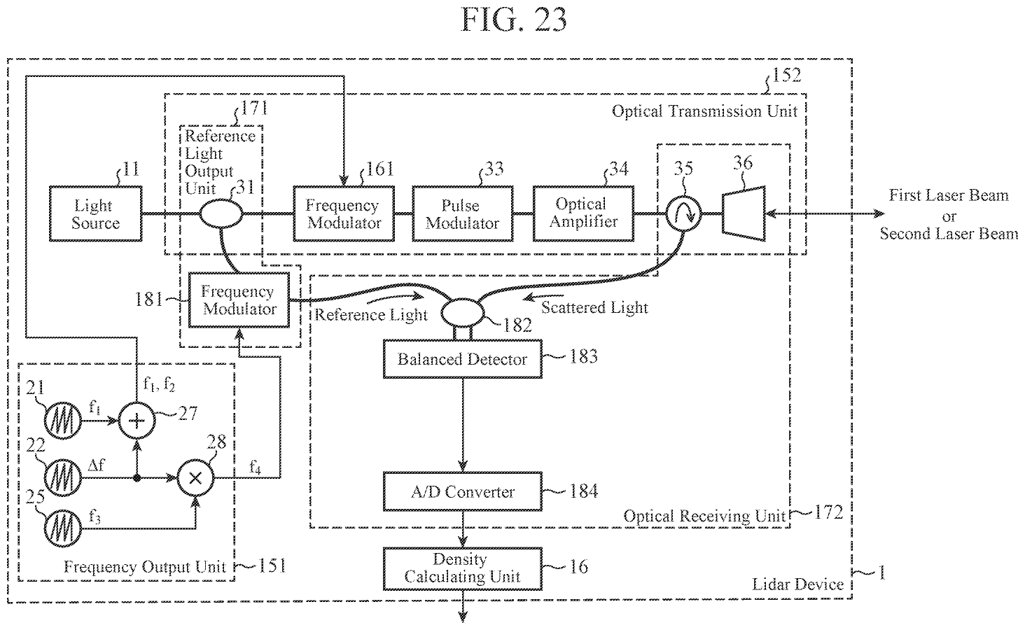

FIG. 23 is a configuration diagram illustrating the lidar device 1 according to the fifth embodiment. In FIG. 23, the same reference numerals as those in FIGS. 1 and 19 denote the same or corresponding parts, and thus description thereof is omitted.

The lidar device 1 illustrated in FIG. 23 includes a light source 11, a frequency output unit 151, a reference light output unit 171, an optical transmission unit 152, an optical receiving unit 172, and a density calculating unit 16.

In the lidar device 1 illustrated in FIG. 23, the frequency conversion unit 28 of the frequency output unit 151 outputs the fourth frequency f₄ to the frequency modulator 181.

The reference light output unit 171 includes an optical distributor 31 and a frequency modulator 181.

The reference light output unit 171 modulates the optical frequency f₀ of the laser beam output from the light source 11 by the fourth frequency f₄ output from the frequency output unit 151, and outputs the laser beam modulated by the fourth frequency f₄ to the optical receiving unit 172 as reference light.

The frequency modulator 181 is implemented by, for example, a modulation element using an acousto-optic element or a modulation element using a lithium niobate crystal.

The frequency modulator 181 modulates the optical frequency f₀ of the laser beam output from the optical distributor 31 by the fourth frequency f₄ output from the frequency conversion unit 28.

The frequency modulator 181 outputs the laser beam modulated by the fourth frequency f₄ to the optical multiplexer 182 as reference light. The optical frequency of the reference light is f₀+f₄.

The optical receiving unit 172 includes an optical circulator 35, an optical antenna 36, an optical multiplexer 182, a balanced detector 183, and an A/D converter 184.

The optical receiving unit 172 receives, as scattered light, each of the first laser beam radiated by the optical transmission unit 152 and then scattered by the scatterer and the second laser beam radiated by the optical transmission unit and then scattered by the scatterer, and detects interference light between the scattered light and the reference light.

The optical multiplexer 182 is implemented by, for example, a beam splitter or a fiber type coupler.

The optical multiplexer 182 detects interference light between the scattered light output from the optical circulator 35 and the reference light output from the frequency modulator 181.

The optical multiplexer 182 outputs the interference light to the balanced detector 183.

That is, since the optical frequency of the reference light is f₀+f₄, the optical multiplexer 182 outputs the interference light having the optical frequency f₁−f₄+Δf_{sft} and the interference light having the optical frequency f₂−f₄+Δf_{sft} to the balanced detector 183 when the lidar device 1 and the scatterer or the like are close to each other.

When the lidar device 1 and the scatterer or the like are away from each other, the optical multiplexer 182 outputs the interference light having the optical frequency f₁ f₄−Δf_{sft} and the interference light having the optical frequency f₂−f₄−Δf_{sft} to the balanced detector 183.

When the lidar device 1 does not move and the scatterer or the like does not move, the optical multiplexer 182 outputs the interference light having the optical frequency f₁−f₄ and the interference light having the optical frequency f₂−f₄ to the balanced detector 183.

The balanced detector 183 is implemented by, for example, a balanced receiver that reduces in-phase noise by using two photodiodes.

The balanced detector 183 converts the interference light output from the optical multiplexer 182 into an electric signal.

The balanced detector 183 outputs the electric signal to the A/D converter 184.

The A/D converter 184 converts the analog electric signal output from the balanced detector 183 into a digital signal.

The A/D converter 184 outputs the digital signal to the density calculating unit 16.

Next, the lidar device 1 illustrated in FIG. 23 will be described.

The light source 11 outputs the laser beam to the optical distributor 31.

The signal multiplexer 27 of the frequency output unit 151 outputs each of the first frequency f₁ and the second frequency f₂ to the frequency modulator 161.

The frequency conversion unit 28 of the frequency output unit 151 outputs the fourth frequency f₄ to the frequency modulator 181.

Upon receiving the laser beam from the light source 11, the optical distributor 31 distributes the laser beam at a predetermined ratio.

The optical distributor 31 outputs one of the distributed laser beams to the frequency modulator 161 and outputs the other of the distributed laser beams to the frequency modulator 181.

Since the operations of the frequency modulator 161, the pulse modulator 33, the optical amplifier 34, the optical circulator 35, and the optical antenna 36 are similar to those in the fourth embodiment, detailed description thereof will be omitted.

In the lidar device 1 illustrated in FIG. 23, the first laser beam and the second laser beam are simultaneously radiated from the optical antenna 36 to the space.

The optical antenna 36 receives each of the first laser beam scattered by the scatterer and the second laser beam scattered by the scatterer as scattered light.

The optical circulator 35 outputs the scattered light received by the optical antenna 36 to the optical multiplexer 182.

Upon receiving the laser beam from the optical distributor 31, the frequency modulator 181 modulates the optical frequency f₀ of the laser beam by the fourth frequency f₄ output from the frequency conversion unit 28.

The frequency modulator 181 outputs the laser beam modulated by the fourth frequency f₄ to the optical multiplexer 182 as reference light. The optical frequency of the reference light is f₀+f₄.

The optical multiplexer 182 acquires scattered light from the optical circulator 35 and reference light from the frequency modulator 181.

The optical multiplexer 182 detects interference light between scattered light and reference light.

For example, when the lidar device 1 moves, or when the gas and the scatterer move, the scattered light is subjected to the Doppler shift, and the optical frequencies f₀+f₁ and f₀+f₂ of the scattered light are shifted. That is, when the lidar device 1 and the scatterer or the like are close to each other, the optical frequencies f₀+f₁ and f₀+f₂ of the scattered light are increased by, for example, the frequency Δf_{sft}. Since the optical frequency of the reference light output from the frequency modulator 181 is f₀+f₄, the optical frequency of the interference light between the scattered light having the optical frequency f₀+f₁+Δf_{sft} output from the optical circulator 35 and the reference light is f₁−f₄+Δf_{sft} (=f₀+f₁+Δf_{sft}−(f₀+f₄)). In addition, the optical frequency of the interference light between the scattered light having the optical frequency f₀+f₂+Δf_{sft} output from the optical circulator 35 and the reference light is f₂−f₄+Δf_{sft} (=f₀+f₂+Δf_{sft}−(f₀+f₄)).

When the lidar device 1 and the scatterer or the like are away from each other, the optical frequencies f₀+f₁ and f₀+f₂ of the scattered light are decreased by, for example, the frequency Δf_{sft}. Since the optical frequency of the reference light output from the frequency modulator 181 is f₀+f₄, the optical frequency of the interference light between the scattered light having the optical frequency f₀+f₁−Δf_{sft} output from the optical circulator 35 and the reference light is f₁−fₐ−Δf_{sft} (=f₀+f₁−Δf_{sft}−(f₀+f₄)). In addition, the optical frequency of the interference light between the scattered light having the optical frequency f₀+f₂−Δf_{sft} output from the optical circulator 35 and the reference light is f₂−f₄−Δf_{sft} (=f₀+f₂−Δf_{sft}−(f₀+f₄)).

When the lidar device 1 does not move and the scatterer or the like does not move, the optical frequencies f₀+f₁ and f₀+f₂ of the scattered light do not change. Δf_{sft}=0. Since the optical frequency of the reference light output from the frequency modulator 181 is f₀+f₄, the optical frequency of the interference light between the scattered light having the optical frequency f₀+f₁ output from the optical circulator 35 and the reference light is f₁−f₄ (=f₀+f₁−(f₀+f₄)). In addition, the optical frequency of the interference light between the scattered light having the optical frequency f₀+f₂ output from the optical circulator 35 and the reference light is f₂−f₄(=f₀+f₂−(f₀+f₄)).

Therefore, when the lidar device 1 and the scatterer or the like are close to each other, the optical multiplexer 182 outputs the interference light having the optical frequency f₁−f₄+Δf_{sft} and the interference light having the optical frequency f₂−f₄+Δf_{sft} to the balanced detector 183.

When the lidar device 1 and the scatterer or the like are away from each other, the optical multiplexer 182 outputs the interference light having the optical frequency f₁ f₄−Δf_{sft} and the interference light having the optical frequency f₂−f₄−Δf_{sft} to the balanced detector 183.

When the lidar device 1 does not move and the scatterer or the like does not move, the optical multiplexer 142 outputs the interference light having the optical frequencies f₁−f₄ and the interference light having the optical frequencies f₂−f₄ to the balanced detector 183.

The balanced detector 183 acquires interference light from the optical multiplexer 182 and converts the interference light into an electric signal.

The balanced detector 183 outputs the electric signal to the A/D converter 184.

The A/D converter 184 acquires the electric signal from the balanced detector 183.

The A/D converter 184 converts the analog electric signal into a digital signal and outputs the digital signal to the density calculating unit 16.

Upon receiving the digital signal from the A/D converter 184, the density calculating unit 16 calculates the density of the gas.

That is, when the lidar device 1 and the scatterer or the like are close to each other, the density calculating unit 16 calculates the density of the gas by substituting the intensity of the reception spectrum at the frequency f₁−f₄+Δf_{sft} and the intensity of the reception spectrum at the frequency f₂−f₄+Δf_{sft} into Formula (2).

When the lidar device 1 and the scatterer or the like are away from each other, the density calculating unit 16 calculates the density of the gas by substituting the intensity of the reception spectrum at the frequency f₁−f₄−Δf_{sft} and the intensity of the reception spectrum at the frequency f₂−f₄−Δf_{sft} into Formula (2).

When the lidar device 1 does not move and the scatterer or the like does not move, the density calculating unit 16 calculates the density of the gas by substituting the intensity of the reception spectrum at the frequency f₁−f₄ and the intensity of the reception spectrum at the frequency f₂−f₄ into Formula (2).

Also in the lidar device 1 illustrated in FIG. 23, similarly to the lidar device 1 illustrated in FIG. 19, the density of the gas can be calculated without including two light sources.

In the lidar device 1 illustrated in FIG. 23, the frequency discriminator 164, the frequency mixer 165, and the signal multiplexer 166 are unnecessary.

Note that, in the present disclosure, it is possible to freely combine each embodiment, to modify any components of each embodiment, or to omit any components in each embodiment.

### INDUSTRIAL APPLICABILITY

The present disclosure is suitable for a lidar device.

### REFERENCE SIGNS LIST

1: lidar device, 11: light source, 12: frequency output unit, 13: reference light output unit, 14: optical transmission unit, 15: optical receiving unit, 16: density calculating unit, 21: first frequency oscillator, 22, 22′: second frequency oscillator, 23, 23′: frequency mixer, 24: frequency conversion unit, 25: third frequency oscillator, 26: frequency mixer, 27: signal multiplexer, 28: frequency conversion unit, 31: optical distributor, 32: frequency modulator, 33: pulse modulator, 34: optical amplifier, 35: optical circulator, 36: optical antenna, 37: optical multiplexer, 38: balanced detector, 39: frequency discriminator, 40: frequency mixer, 41: signal multiplexer, 42: A/D converter, 51: frequency analysis unit, 52: spectrum intensity calculating unit, 53: density calculation processing unit, 61: frequency analysis circuit, 62: spectrum intensity calculating circuit, 63: density calculation processing circuit, 71: memory, 72: processor, 81: frequency output unit, 82: optical transmission unit, 83: optical receiving unit, 84: temperature calculating unit, 91: frequency modulator, 92: optical multiplexer, 93: balanced detector, 94: frequency discriminator, 95: signal multiplexer, 96: A/D converter, 101: frequency analysis unit, 102: spectrum intensity calculating unit, 103: temperature calculation processing unit, 111: frequency analysis circuit, 112: spectrum intensity calculating circuit, 113: temperature calculation processing circuit, 121: memory, 122: processor, 131: reference light output unit, 132: optical receiving unit, 141: frequency modulator, 142: optical multiplexer, 143: balanced detector, 144: A/D converter, 151: frequency output unit, 152: optical transmission unit, 153: optical receiving unit, 161: frequency modulator, 162: optical multiplexer, 163: balanced detector, 164: frequency discriminator, 165: frequency mixer, 166: signal multiplexer, 167: A/D converter, 171: reference light output unit, 172: optical receiving unit, 181: frequency modulator, 182: optical multiplexer, 183: balanced detector, 184: A/D converter

1. A lidar device that radiates a first laser beam having a wavelength included in an absorption wavelength band of an observation target gas and a second laser beam having a lower absorption rate by the gas than that of the first laser beam to a space where the gas is present, the lidar device comprising:
a light source to output a laser beam;
a frequency outputter to output a first frequency or a second frequency different from the first frequency;
a reference light outputter to output the laser beam output from the light source as reference light;
an optical transmitter to generate the first laser beam by modulating an optical frequency of the laser beam output from the light source by the first frequency, generate the second laser beam by modulating the optical frequency of the laser beam output from the light source by the second frequency, and radiate each of the first laser beam and the second laser beam to the space; and
an optical receiver to receive, as scattered light, the first laser beam radiated by the optical transmitter and then scattered by a scatterer floating in the space or the second laser beam radiated by the optical transmitter and then scattered by the scatterer, and detect interference light between the scattered light and the reference light, wherein the first laser beam has a first wavelength within an absorption wavelength band of the gas and the second laser beam has a second wavelength out of the absorption wavelength band of the gas, and
wherein the frequency outputter outputs the first frequency in a first period, and outputs the second frequency in a second period different from the first period.

2. A lidar device that radiates a first laser beam having a wavelength included in an absorption wavelength band of an observation target gas and a second laser beam having a lower absorption rate by the gas than that of the first laser beam to a space where the gas is present, the lidar device comprising:
a light source to output a laser beam;
a frequency outputter to output a first frequency or a second frequency different from the first frequency;
a reference light outputter to output the laser beam output from the light source as reference light;
an optical transmitter to generate the first laser beam by modulating an optical frequency of the laser beam output from the light source by the first frequency, generate the second laser beam by modulating the optical frequency of the laser beam output from the light source by the second frequency, and radiate each of the first laser beam and the second laser beam to the space; and
an optical receiver to receive, as scattered light, the first laser beam radiated by the optical transmitter and then scattered by a scatterer floating in the space or the second laser beam radiated by the optical transmitter and then scattered by the scatterer, and detect interference light between the scattered light and the reference light, wherein the first laser beam has a first wavelength within an absorption wavelength band of the gas and the second laser beam has a second wavelength out of the absorption wavelength band of the gas, and
wherein
the frequency outputter includes:
a first frequency oscillator to oscillate the first frequency;
a second frequency oscillator; and
a frequency mixer to generate the second frequency by adding the first frequency and a frequency that is oscillated by the second frequency oscillator.

3. The lidar device according to claim 2, further comprising,
a density calculator to analyze an optical frequency of interference light detected by the optical receiver and calculates density of the gas from a results of analysis of the optical frequency,
wherein
the optical receiver
when having received the first laser beam scattered by the scatterer, detects interference light between the received first laser beam and the reference light and outputs the interference light to the density calculator, and
when having received the second laser beam scattered by the scatterer, detects interference light between the received second laser beam and the reference light, down-converts an optical frequency of the interference light between the received second laser beam and the reference light using the frequency oscillated by the second frequency oscillator, and outputs the down-converted interference light to the density calculator.

4. The lidar device according to claim 2, wherein
the reference light outputter, when the first frequency is output from the frequency outputter to the optical transmitter, outputs a laser beam output from the light source to the optical receiver as a reference, when the second frequency is output from the frequency outputter to the optical transmitter, without outputting a laser beam output from the light source as a reference light, modulates the optical frequency of the laser beam output from the light source by a frequency oscillated by the second frequency oscillator, and outputs the laser beam modulated by a frequency oscillated by the second frequency oscillator as a reference light to the optical receiver.

5. A lidar device that radiates a first laser beam having a wavelength included in an absorption wavelength band of an observation target gas and a second laser beam having a lower absorption rate by the gas than that of the first laser beam to a space where the gas is present, the lidar device comprising:
a light source to output a laser beam;
a frequency outputter to output a first frequency or a second frequency different from the first frequency;
a reference light outputter to output the laser beam output from the light source as reference light;
an optical transmitter to generate the first laser beam by modulating an optical frequency of the laser beam output from the light source by the first frequency, generate the second laser beam by modulating the optical frequency of the laser beam output from the light source by the second frequency, and radiate each of the first laser beam and the second laser beam to the space; and
an optical receiver to receive, as scattered light, the first laser beam radiated by the optical transmitter and then scattered by a scatterer floating in the space or the second laser beam radiated by the optical transmitter and then scattered by the scatterer, and detect interference light between the scattered light and the reference light, wherein the first laser beam has a first wavelength within an absorption wavelength band of the gas and the second laser beam has a second wavelength out of the absorption wavelength band of the gas, and
wherein
the frequency outputter includes:
a first frequency oscillator to oscillate the first frequency;
a second frequency oscillator to intermittently oscillate the second frequency and intermittently output the second frequency to the optical transmitter; and
a frequency mixer to output the first frequency oscillated by the first frequency oscillator to the reference light outputter when the second frequency is not output from the second frequency oscillator, and outputs a frequency of a sum of the first frequency and the second frequency to the reference light outputter when the second frequency is output from the second frequency oscillator,
the optical transmitter, when the second frequency is not output from the second frequency oscillator, uses a laser beam output from the light source as the first laser beam without modulating the optical frequency of the laser beam output from the light source by the first frequency, and when the second frequency is output from the second frequency oscillator, generates the second laser beam by modulating the optical frequency of the laser beam output from the light source by the second frequency, and
the reference light outputter, when the first frequency is output from the frequency mixer, modulates the optical frequency of the laser beam output from the light source by the first frequency, and outputs the laser beam modulated by the first frequency to the optical receiver as reference light, and when the frequency of the sum is output from the frequency mixer, modulates the optical frequency of the laser beam output from the light source by the frequency of the sum, and outputs the laser beam modulated by the frequency of the sum to the optical receiver as reference light.

6. The lidar device according to claim 1 wherein
the optical receiver
detects interference light between the first laser beam scattered by the scatterer and the reference light, and outputs the interference light between the first laser beam scattered by the scatterer and the reference light to the density calculator, and
detects interference light between the second laser beam scattered by the scatterer and the reference light, down-converts an optical frequency of the interference light between the second laser beam scattered by the scatterer and the reference light using a fourth frequency different from each of the first frequency and the second frequency, and outputs the down-converted interference light to the density calculator.
